(19) United States
(12) Patent Application Publication
(10) Pub. No.: US 2025/0178348 A1
(43) Pub. Date: Jun. 5, 2025

(54) PRINT TILE AND PRINTHEAD ASSEMBLY FOR INKJET PRINTER

(71) Applicant: Kateeva, Inc., Newark, CA (US)

(72) Inventors: Robert D. Taff, Lenexa, KS (US); Christopher Buchner, Sunnyvale, CA (US)

(73) Assignee: Kateeva, Inc., Newark, CA (US)

(21) Appl. No.: 18/838,758

(22) PCT Filed: Feb. 21, 2023
(86) PCT No.: PCT/US2023/062911

§ 371 Date: Aug. 15, 2024

Related U.S. Application Data
(60) Provisional application No. 63/268,346, filed on Feb. 22, 2022.

(51) Int. Cl. B41J 2/155; B41J 2/14; B41J 2/175; B41J 2/18

(52) U.S. Cl. CPC B41J 2/155; B41J 2/1433; B41J 2/1752; B41J 2/17596; B41J 2/18; B41J 2202/19

(57) ABSTRACT

A print tile for a printhead assembly in a printer includes a base plate, a printhead, a nozzle plate attached to the printhead, and a plurality of mounting elements. The base plate has an upper surface, a lower surface opposite the upper surface, and a slot extending through the base plate. The printhead has a lower part received in the slot and including a plurality of nozzles from which a print material is to be ejected in a printing operation. The plurality of mounting elements mounts the nozzle plate to the base plate, while permitting adjustment of a position of the printhead relative to the base plate. The base plate includes first and second adjustable lifts correspondingly under first and second end portions of the nozzle plate, to adjust positions of the first and second end portions of the nozzle plate independently one from another.

### BACKGROUND

Industrial inkjet printers are used to apply materials to large substrates to form devices of all kinds. The substrates can be rigid or flexible, thick or thin, and can be made of an array of materials. The most common types of substrates used in this way are substrates made of various types of glass, which are processed to make electronic displays such as televisions and displays for smart phones.

Such displays are typically made on a large sheet of glass, with many devices mapped out on the sheet. Making multiple devices in one processing pass achieves economy of scale, reducing the unit price of the individual devices. There is a continuing need to enlarge the processing format for display manufacture, which also applies to manufacture of other electronic devices on other substrates.

For display devices, in particular, the promise of increasing economy of scale is challenged by uniformity problems that mount with increasing scale. Manufacturing processes for display devices often result in visible artifacts, such as lines and patterns, in the device that render the device unusable. These problems have been largely solved in current commercial printers, but increasing scale always invites new uniformity problems.

Naturally, as larger substrates with larger print areas are processed, printing takes longer. There is also the parallel need to speed up manufacture of single substrates.

Additionally, there is always a trend in display devices toward higher resolution complicating the drive toward larger format manufacturing. Reducing the size of drops printed on a substrate always comes with the possibility of new uniformity problems. Thus, there is a need to increase the scale and speed of commercial inkjet printing, while also increasing the resolution of commercial inkjet printing, all while maintaining uniform device construction without visible defects.

### SUMMARY

In at least one embodiment, a print tile for a printhead assembly in a printer comprises a base plate, a printhead, a nozzle plate attached to the printhead, and a plurality of mounting elements. The base plate has an upper surface, a lower surface opposite the upper surface in a thickness direction of the base plate, and a slot extending through the base plate from the upper surface to the lower surface. The printhead comprises a lower part received in the slot and having a plurality of nozzles from which a print material is to be ejected in a printing operation. The plurality of mounting elements mounts the nozzle plate to the base plate, while permitting adjustment of a position of the printhead relative to the base plate. The nozzle plate has opposite first and second end portions. The base plate comprises first and second adjustable lifts correspondingly under the first and second end portions of the nozzle plate, to adjust positions of the first and second end portions of the nozzle plate independently one from another in the thickness direction of the base plate.

In at least one embodiment, a print tile for a printhead assembly in a printer comprises a base plate, a plurality of printheads a plurality of nozzle plates correspondingly attached to the plurality of printheads, and a plurality of mounting elements to mount the plurality of nozzle plates to the base plate. The base plate has an upper surface, a lower surface opposite the upper surface in a thickness direction of the base plate, and a plurality of slots extending through the base plate from the upper surface to the lower surface. Each of the plurality of printheads comprises a lower part received in a corresponding slot among the plurality of slots and comprising a plurality of nozzles from which a print material is to be ejected in a printing operation. The plurality of mounting elements comprises, for each nozzle plate among the plurality of nozzle plates, first and second fastening elements correspondingly fastening the first and second end portions of the nozzle plate to the base plate, and a conical screw having a conical surface engaging the first end portion of the nozzle plate, to adjust a position of the first end portion in a rotational direction about an axis at the second end portion of the nozzle plate, the axis oriented in the thickness direction of the base plate.

In at least one embodiment, a printhead assembly for an inkjet printer comprises a housing, a supply arrangement supported at an upper portion of the housing, and a plurality of print tiles removably supported at a lower portion of the housing. Each of the plurality of print tiles comprises a base plate having a plurality of slots, a plurality of printheads each partially received in a corresponding slot among the plurality of slots and comprising a plurality of nozzles from which a print material is to be ejected in a printing operation, a plurality of nozzle plates correspondingly attached to the plurality of printheads, a plurality of mounting elements adjustably fastening the plurality of nozzle plates to the base plate, and, above the plurality of printheads, a connector set comprising at least one fluid connector and at least one electrical connector fluidly and electrically coupled, respectively, to the plurality of printheads. The supply arrangement comprises, for each of the plurality of print tiles, a corresponding connector set coupled to the connector set of the print tile when the print tile is removably attached to the supply arrangement from below by a fastening structure and an alignment structure. The alignment structure comprises at least one alignment pin on one of the supply arrangement and the print tile, and at least one alignment hole on the other of the supply arrangement and the print tile, the at least one alignment pin being aligned with and received in the at least one alignment hole.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a top, perspective view of an inkjet printer, according to one embodiment.

FIG. 2 is a bottom, perspective view of a printhead assembly, according to one embodiment.

FIG. 3 is an elevated corner view of a print tile of a printhead assembly, according to one embodiment.

FIG. 4A is a partially disassembled top perspective view of a printhead assembly, according to one embodiment.

FIG. 4B is a bottom perspective view of the partially disassembled printhead assembly of FIG. 4A, according to one embodiment.

FIG. 5A is a partial, top perspective view of a bottom part of a print tile, showing a base plate, nozzle plates and printheads, according to one embodiment.

FIG. 5B is a top plan view of a printhead, a nozzle plate and a portion of the base plate of FIG. 5A, according to one embodiment.

FIG. 5C is a schematic cross-sectional view taken along line I-I in FIG. 5A, according to one embodiment.

FIG. 5D is a top plan view of the printheads, the nozzle plates and the base plate of FIG. 5A, with interposing spacers, according to one embodiment.

FIG. 5E is a top perspective view of a spacer, according to one embodiment.

FIG. 6A is a side view of a conical screw, according to one embodiment.

FIG. 6B is a perspective view of an end portion of a nozzle plate, with the conical screw of FIG. 6A, according to one embodiment.

FIG. 6C is a perspective view similar to FIG. 6B, showing the operation of the conical screw of FIG. 6A, according to one embodiment.

FIG. 6D is a top plan view of printheads, nozzle plates and a base plate, with conical screws of FIG. 6A, according to one embodiment.

FIG. 7A is a perspective view of end portions of nozzle plates on a base plate, with position fixing elements, according to one embodiment.

FIG. 7B is a perspective view similar to FIG. 7A, with position adjusting and position fixing elements, according to one embodiment.

FIGS. 8A and 8B are side views of different fastening elements for fastening opposite ends of a nozzle plate to a base plate, according to one embodiment.

FIG. 8C is a cross-sectional view of a fastening element, in an alternative embodiment.

FIG. 8D is a top plan view of a printhead, a nozzle plate, and a portion of a base plate, according to one embodiment.

FIG. 8E is a partial, top perspective view of a bottom part of a print tile, according to one embodiment.

FIG. 8F is a partial cross-sectional view of a biasing element in FIG. 8E, according to one embodiment.

FIG. 9A is a partial, top perspective view of a bottom part of a print tile, showing a base plate, a nozzle plate and a printhead, according to one embodiment.

FIG. 9B is a schematic cross-sectional view taken along line II-II in FIG. 9A, according to one embodiment.

FIG. 9C is a schematic cross-sectional view taken along line III-III in FIG. 9A, according to one embodiment.

FIG. 9D includes a side view and a top view of a mounting element in FIG. 9C, according to one embodiment.

FIG. 10A is a perspective view of a top part of a print tile and a corresponding connector part of a supply arrangement to be coupled to the print tile, according to one embodiment.

FIGS. 10B-10E are schematic cross-sectional views showing various states while the top part of the print tile and the corresponding connector part of the supply arrangement are being coupled together, according to one embodiment.

FIG. 11A is a bottom view of a printhead assembly, according to one embodiment.

FIG. 11B is an enlarged view of a region in FIG. 11A.

### DETAILED DESCRIPTION

The following disclosure provides many different embodiments, or examples, for implementing different features of the provided subject matter. Specific examples of components, values, operations, materials, arrangements, etc., are described below to simplify the present disclosure. These are, of course, merely examples and are not intended to be limiting. Other components, values, operations, materials, arrangements, etc., are contemplated. For example, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some embodiments, an inkjet printer has a printhead assembly with multiple removable and replaceable print tiles, each print tile comprising multiple removable and replaceable printheads, and each printhead comprising multiple nozzles for ejecting a print material in a printing operation. To ensure high printing quality, it is useful to align nozzles of multiple printheads. For this purpose, in at least one embodiment, each printhead is attached to a nozzle plate, and the nozzle plate is mounted on a base plate of a print tile by a plurality of mounting elements which permits adjustment of a position of the nozzle plate in at least one direction. As a result, the position of the printhead attached to the nozzle plate and the corresponding nozzles is also adjustable in at least one direction. In the description herein, unless otherwise specified, the position (and its adjustment and/or alignment) of a printhead means the position (and its adjustment and/or alignment) of a nozzle plate attached to the printhead. The at least one direction in which the position of the printhead is adjustable may be any one or more translational directions along x-, y-, z-axes and/or any one or more rotational directions about the x-, y-, z-axes. In at least one embodiment, the plurality of mounting elements further permits thermal expansion of the printhead and/or the attached nozzle plate in at least one direction. In at least one embodiment, each print tile is removably mounted to a supply arrangement of the printhead assembly by a blind connection arrangement using at least one pair of an alignment pin and an alignment hole. One or more advantages are obtainable in some embodiments, as described herein.

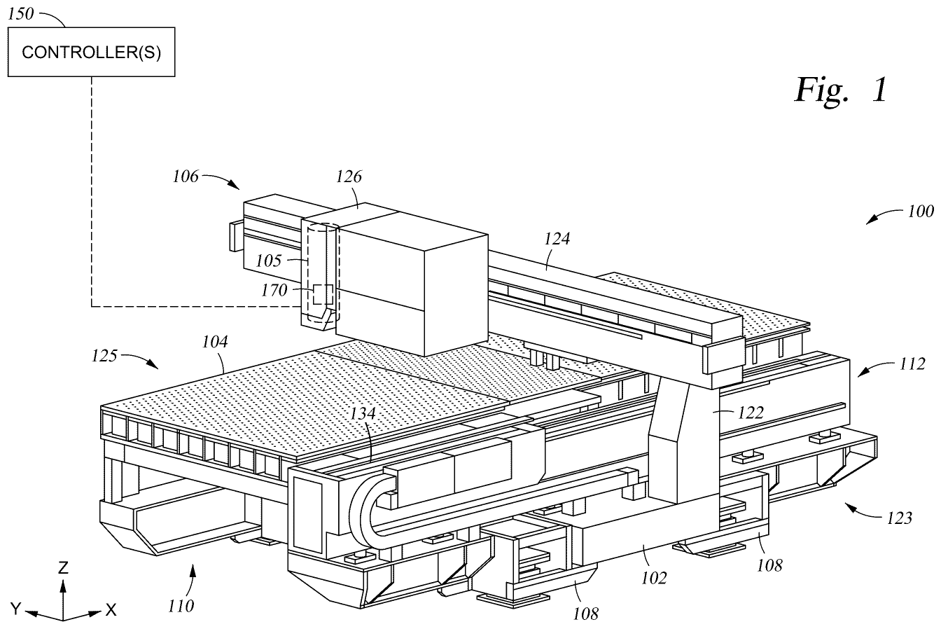

FIG. 1 is a top, perspective view of an inkjet printer 100, according to one embodiment. The inkjet printer 100 has a massive base 102 with a substrate support 104 and a print support disposed 106 on the base 102. The substrate support 104 is a flotation support that provides a gas cushion to support a substrate above the surface of the substrate support 104 without contacting the surface. The base 102, in this case, is disposed on two flotation supports 108 that float the base 102 on a gas cushion.

The substrate support 104 extends from a first end 110 of the printer 100 to a second end 112 of the printer, opposite from the first end 110. Gas for the flotation support is supplied to a plurality of openings 114 in the surface of the substrate support 104. The print support 106 comprises a first stand 122 located on a first side 123 of the substrate support 104 and a second stand (not shown) located on a second side 125 of the substrate support 104 opposite from the first side 123, such that the substrate support 104 extends between the first stand 122 and the second stand. The substrate support 104 has a long dimension, running from the first end 110 to the second end 112, which generally defines an axis referred to as the “y” axis. The first and second stands extend from the base 102 in a direction that defines an axis referred to as the “z” axis, which is perpendicular to the y axis. A substrate handler 134 is disposed alongside the substrate support 104 to move a substrate along the substrate support 104 during processing.

The print support 106 comprises a printhead assembly support 124 that rests on the first and second stands. The printhead assembly support 124 extends in a direction that defines an axis referred to as the “x” axis, which is perpendicular to the y axis and the z axis. A printhead assembly 126 is coupled to the printhead assembly support 124 by a printhead traveler (not shown) that provides movement of the printhead assembly 126 along the printhead assembly support 124, for example using a gas cushion. The printhead assembly 126 thus moves along the x axis. A controller, such as the controller 150, controls actuators that provide motive force to move the traveler along the x-axis direction.

In some embodiments, the controller 150 comprises at least one hardware processor configured to control one or more operations of the inkjet printer 100 as described herein. Examples of such a processor include, but are not limited to, a microprocessor, a central processing unit (CPU), a multi-processor, a distributed processing system, an application specific integrated circuit (ASIC), or the like. In at least one embodiment, the controller 150 further comprises a non-transitory computer-readable storage device storing data and/or software to be used and/or executed by the processor. The storage device comprises an electronic, magnetic, optical, electromagnetic, infrared, and/or a semiconductor system (or apparatus or device) for storing instructions and/or data in a non-transitory manner. For example, the storage device includes a semiconductor or solid-state memory, a magnetic tape, a removable computer diskette, a random access memory (RAM), a read-only memory (ROM), a rigid magnetic disk, and/or an optical disk. As examples of optical disks, the storage device includes a compact disk-read only memory (CD-ROM), a compact disk-read/write (CD-R/W), and/or a digital video disc (DVD). In at least one embodiment, the controller 150 further comprises at least one interface circuitry for communication with external devices and/or a user. For example, the interface circuitry includes one or more of a network interface, keyboard, keypad, mouse, trackball, trackpad, cursor direction keys, card reader, communication port, display, signal light, printer and/or audio device for communicating information to/from the processor. For example, the network interface includes one or more of wireless network interfaces such as BLUETOOTH, WIFI, WIMAX, GPRS, or WCDMA; or wired network interface such as ETHERNET, USB, or IEEE-1394. In some embodiments, the controller 150 comprises several separate controllers each configured to control one or more operations or functions of the inkjet printer 100. The described configuration of the inkjet printer 100 is an example. Other inkjet printer configurations are within the scopes of various embodiments.

In at least one embodiment, for depositing a print material onto a substrate in a printing operation, the substrate support 104 supports the substrate thereon while the substrate is being moved along the y-axis direction. The printhead assembly 126 is coupled to the printhead assembly support 124 and is moved along the printhead assembly support 124 in the x-axis direction, while the print material is deposited or ejected from the printhead assembly 126 onto the underlying substrate.

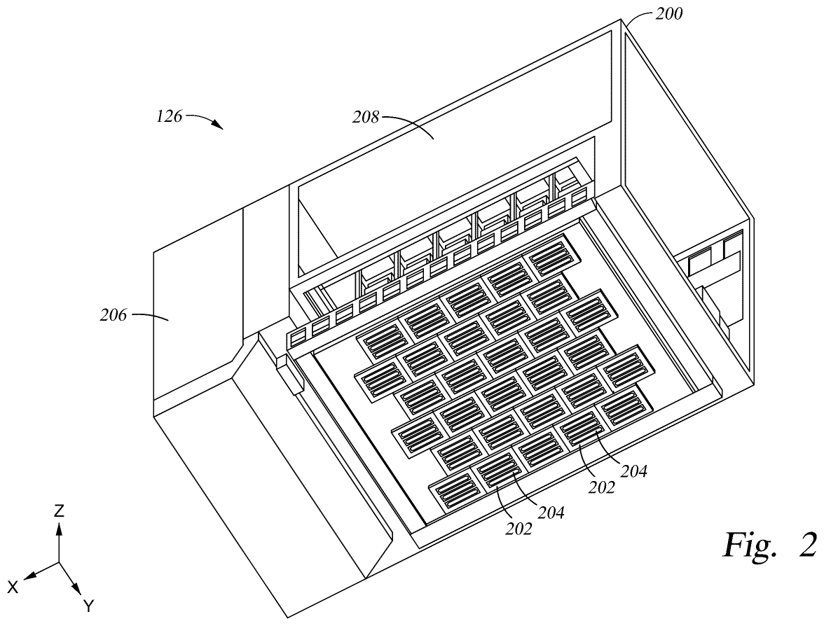

FIG. 2 is a bottom, perspective view of the printhead assembly 126, according to one embodiment. In FIG. 2, the printhead assembly 126 is illustrated as being seen from below, i.e., in an upward direction from the substrate support 104.

The printhead assembly 126 comprises a housing 200, and a plurality of print tiles 202 supported on the housing 200 and arranged in rows in a staggered arrangement. Each print tile 202 has a plurality of printheads 204, with each printhead 204 having a plurality of nozzles. The configuration with three printheads 204 for each print tile 202 in FIG. 2 is just an example. Any number of printheads per print tile, e.g., two or four printheads per print tile, is possible. The nozzles are too small in the view of FIG. 2 to be specifically visible. In at least one embodiment, the nozzles of each printhead 204 are arranged in an array with multiple rows and columns. In a printing operation, a print material is ejected from the nozzles of one or more printheads 204 and travels toward a substrate disposed on the substrate support 104. One or more of the plurality of print tiles 202 can be removed and/or rearranged to change the print tile and/or printhead configurations based on printing needs. For example, where multiple print materials may need to be deposited on a substrate, using a printhead assembly with more nozzles or print tiles offers more ways to deposit the multiple materials. Alternately, where fewer materials are deposited, a printhead assembly with fewer nozzles or print tiles may offer all the flexibility that is needed to deposit the materials while allowing for faster processing and print plan rendering. The described print tile and printhead configuration is an example. Other configurations are within the scopes of various embodiments. For example, in at least one embodiment, it is sufficient that the printhead assembly 126 comprises a print tile 202 instead of multiple print tiles, and/or each print tile 202 comprises a printhead 204 instead of multiple printheads.

The housing 200 further comprises a compartment 206 next to the printheads 204, and a compartment 208 above (in the z-axis direction) the printheads 204. At least a part of a fluid recirculation circuit is housed in the compartments 206, 208 to be supported by the housing 200, and to recirculate the print material, e.g., a fluid or liquid, to and from each of the printheads 204. In an example configuration, one or more reservoirs of the fluid recirculation circuit is/are housed in the compartment 206, and a delivery system with one or more manifolds, conduits, and/or valves is housed in the compartment 208 for recirculating the print material between the reservoirs and the printheads 204.

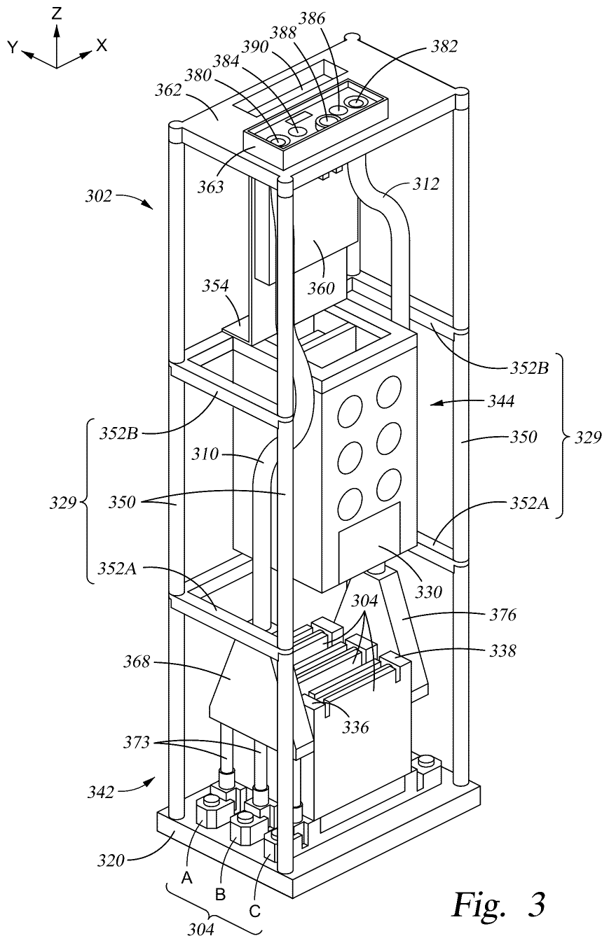

FIG. 3 is an elevated corner view of a print tile 302 of a printhead assembly, according to one embodiment. In some embodiments, the print tile 302 corresponds to any one of the print tiles 202 of the printhead assembly 126, as described herein. The print tile 302 comprises a fluid member 342 and an electronic member 344 that fit together by a case 329 to form the print tile 302.

The fluid member 342 has three printheads 304 correspondingly attached to nozzle plates A-C which are mounted on a base plate 320. In some embodiments, the printheads 304 correspond to the printheads 204 as described herein. Unless otherwise described, the printheads 304 and the corresponding nozzle plates A-C are configured similarly. The number of printheads 304 and the corresponding nozzle plates can be other than three.

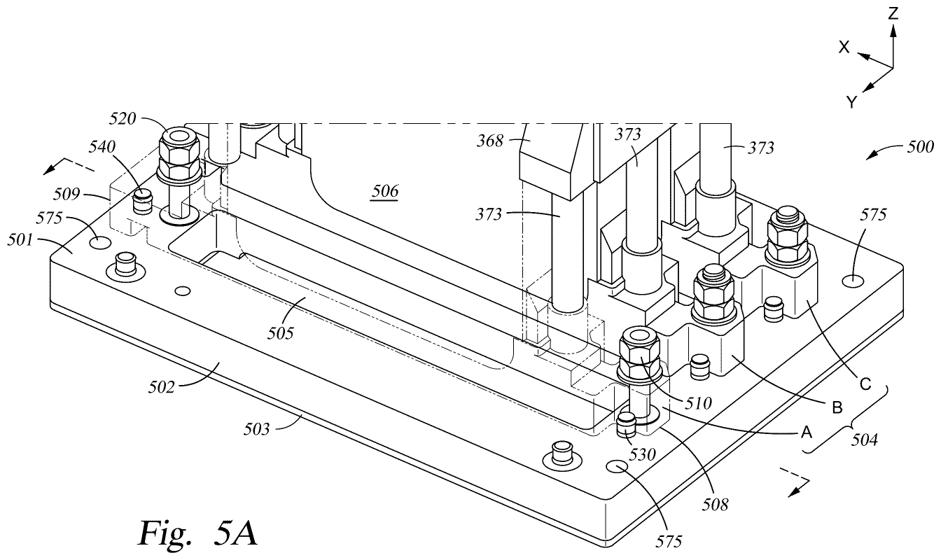

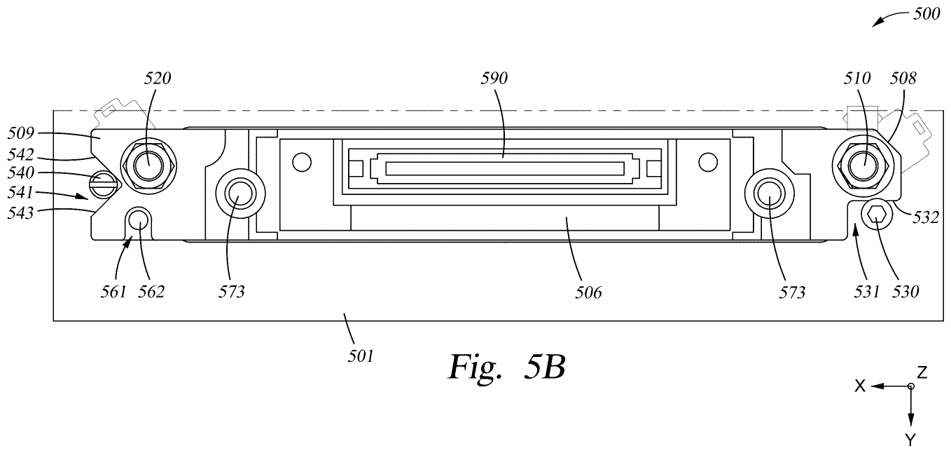

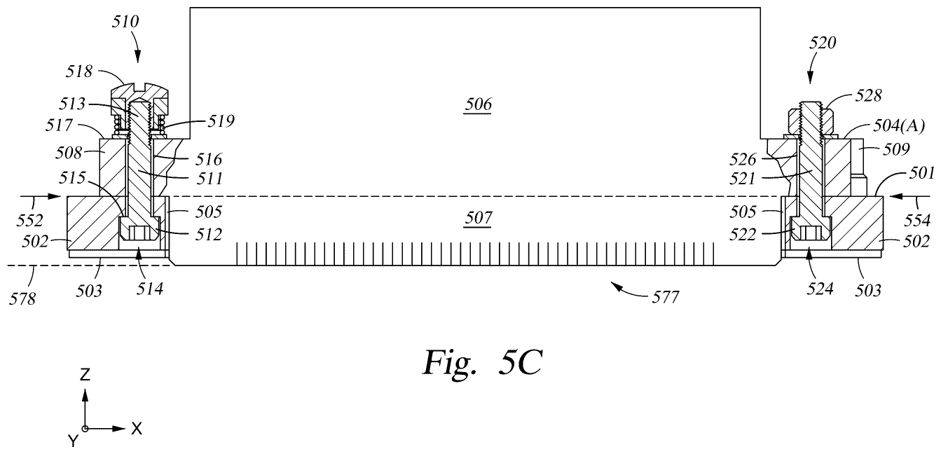

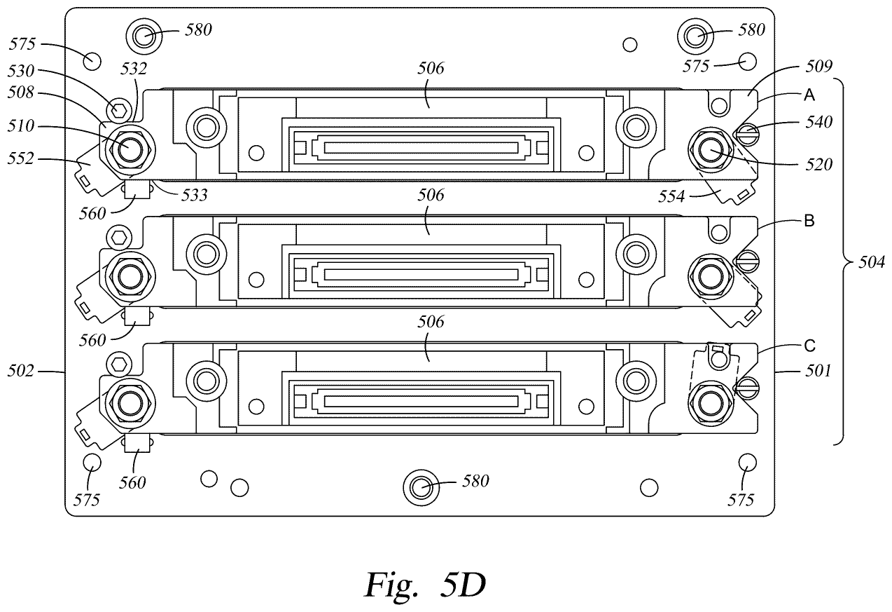

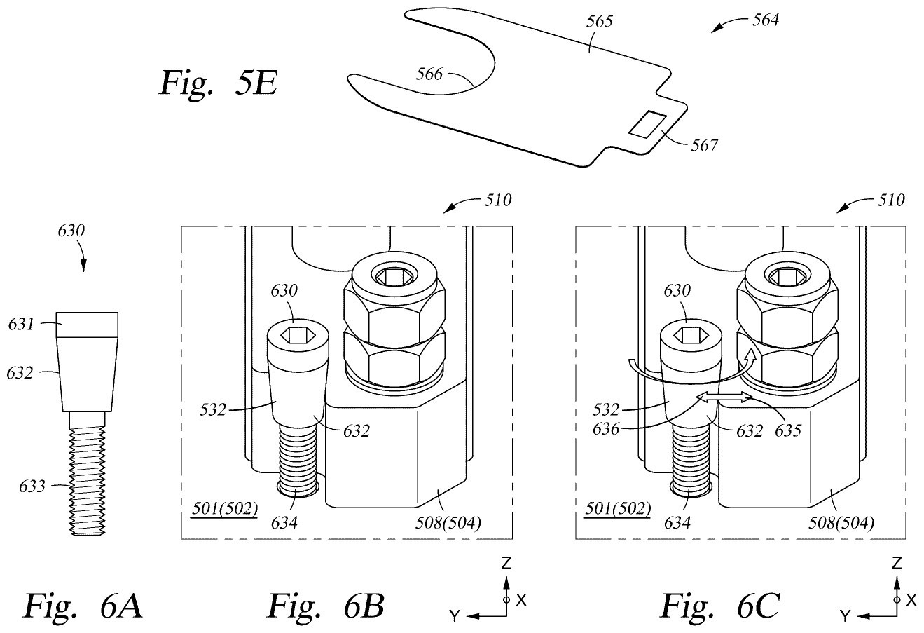

The printheads 304 are attached by ways of the corresponding nozzle plates A-C to the base plate 320 that provides secure mounting for the print tile 302 to the printhead assembly 126, along with openings to expose nozzles (not shown) of the printheads 304 at a nozzle surface (not shown) of the base plate 320. The printheads 304 are aligned at the base plate 320, so the nozzles of all the printheads 304 are disposed substantially in a plane at the nozzle surface of the base plate 320, and so opposite edges of the printheads 304 are aligned. The printheads 304 are spaced apart along the base plate 320, with a constant uniform spacing between adjacent printheads 304 (e.g., along the y-axis direction). Each printhead 304 has a plurality of print nozzles, not visible in FIG. 3, which are distributed along a longitudinal axis of the printhead 304 (e.g., along the x-axis direction) in one or more rows. Various configurations for mounting the printheads 304 by ways of the corresponding nozzle plates A-C to the base plate 320 in accordance with some embodiments are described with respect to FIGS. 5-9D.

The printheads 304 are fluidly coupled to a fluid conduit system for delivering print material to the printheads 304 and returning material from the printheads 304. The fluid conduit system has a supply conduit 310 and a return conduit 312, the supply conduit 310 fluidly coupled to a first side 336 of each of the printheads 304 and the return conduit 312 fluidly coupled to a second side 338 of each of the printheads 304 opposite from the first side 336. The supply conduit 310 and the return conduit 312 are fluidly coupled to corresponding fluid connectors 380, 382 at an end plate 362 opposite to the base plate 320 along the height direction of the print tile 302, e.g., along the z-axis direction. The supply conduit 310 extends from the fluid connector 380 to a supply manifold 368 at the first side 336 of the printheads 304. The supply manifold 368 internally divides the flow supplied by the supply conduit 310 into three divided flows, and supplies the divided flows through three conduits 373 (one of which is not visible in FIG. 3) to the first side 336 of each of the printheads 304 to deliver print material to the printheads 304. The supply manifold 368 is configured to deliver print material to each printhead 304 with essentially no difference in pressure drop so that ejection of print material from nozzles of the printheads 304 can be controlled precisely. An identical return manifold 376, with exit conduits (not visible in FIG. 3), fluidly couples the second end 338 of each printhead 304 to the return conduit 312. Print material circulates to and from the printheads 304, through the supply conduit 310 and return conduit 312, to maintain homogeneity of the print material while printing proceeds or is paused. Thus, while no print material is being ejected from nozzles of the printheads 304 of the printhead assembly 126, print material is circulated to and from the printheads 304 to maintain mixing of the print material.

The case 329 comprises four strength members 350 (one of which is not visible in FIG. 3) arranged in a rectangular configuration and extending, parallel one to the others, in the height direction of the print tile 302, e.g., along the z-axis direction. The cage 329 also comprises two web members, a first web member 352A and a second web member 352B, that couple to all the strength member 350 to provide structural rigidity to the cage 329. The web members 352A, 352B are each u-shaped members that extend linearly between adjacent strength members 350 along three sides of the rectangle defined by the strength members 350. The base plate 320 engages with lower ends of the strength members 350, and the end plate 362 engages with upper ends of the strength members 350 to complete the cage 329.

In an alternative embodiment, each of the strength members 350 comprises a lower post and an upper post, and the second web member 352B is replaced by an upper mounting plate and a lower mounting plate. The lower post of each strength member 350 extends between and connects the base plate 320 and the lower mounting plate. The upper post of each strength member 350 extends between and connects the upper mounting plate and the end plate 362. The upper mounting plate and the lower mounting plate are fastened together by a plurality of spring shoulder screws each with a compression spring disposed between the upper mounting plate and the lower mounting plate. As a result, an upper section of the case 329 including the end plate 362, the upper posts and the upper mounting plate can float resiliently on the springs while being attached to a lower section of the case 329 including the lower mounting plate, the lower posts and the base plate 320. In other embodiments, the springs can be tensile springs. Other flexible fasteners can be used.

The electronic member 344 has a driver box 330 to house printhead drive circuitry. The driver box 330 is attached to an electronic support plate 354 which, in turn, is attached to the second web member 352B. The electronic support plate 354 provides structural support and positioning for electronic elements of the print tile 302 to make electrical connections. The driver box 330 attached to the electronic support plate 354 is located between the electronic support plate 354 and the first web member 352A. An electronic interface member 360 is attached to the electronic support plate 354, and is located between the electronic support plate 354 and the end plate 362.

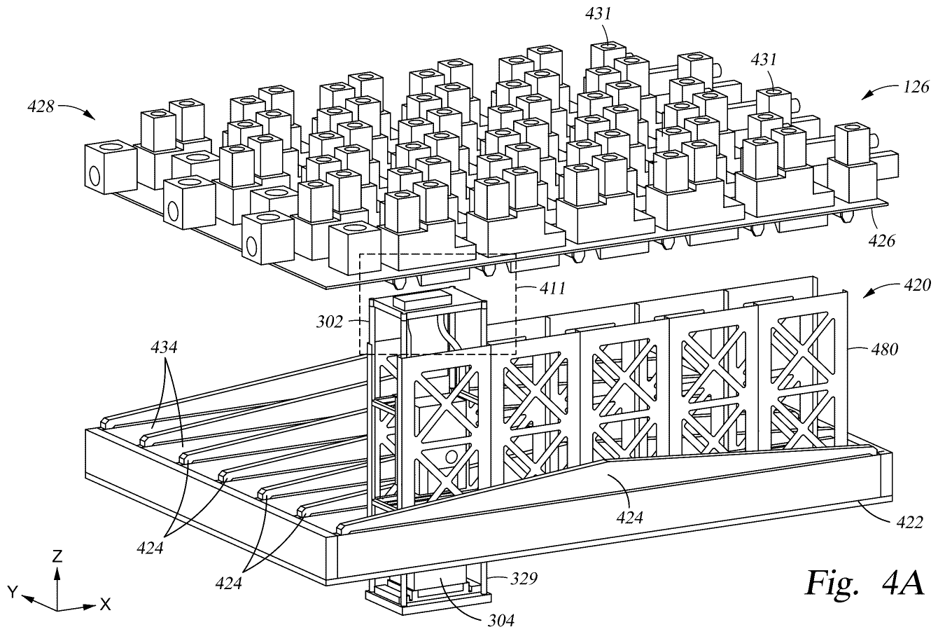

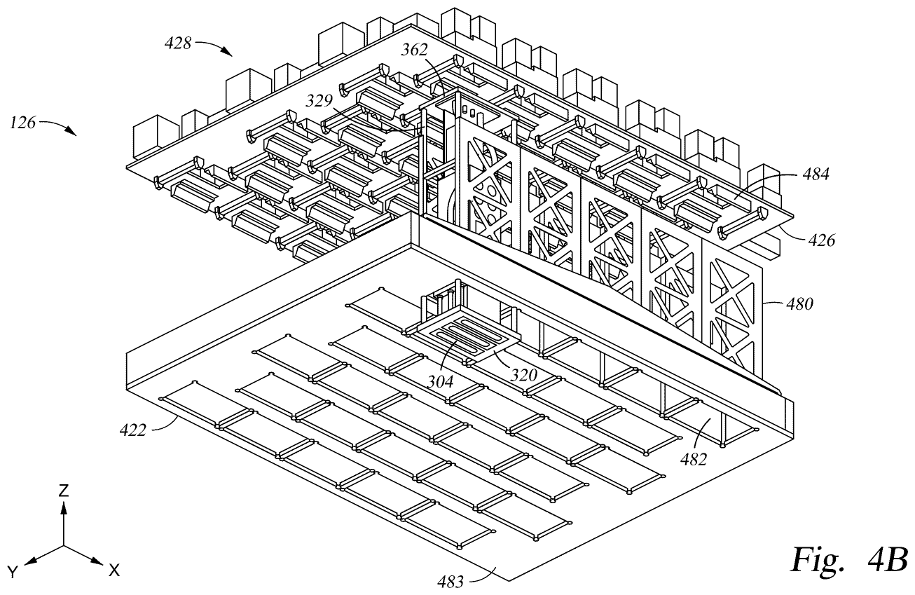

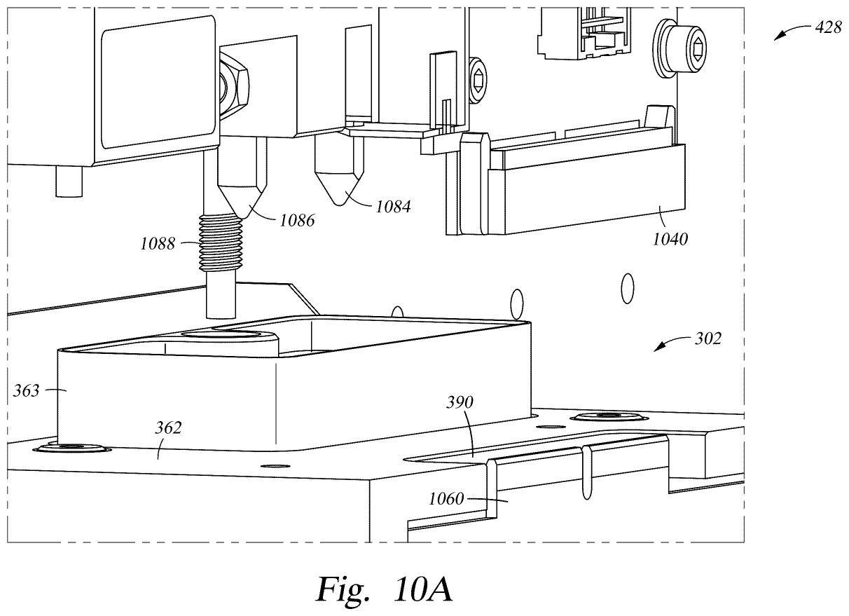

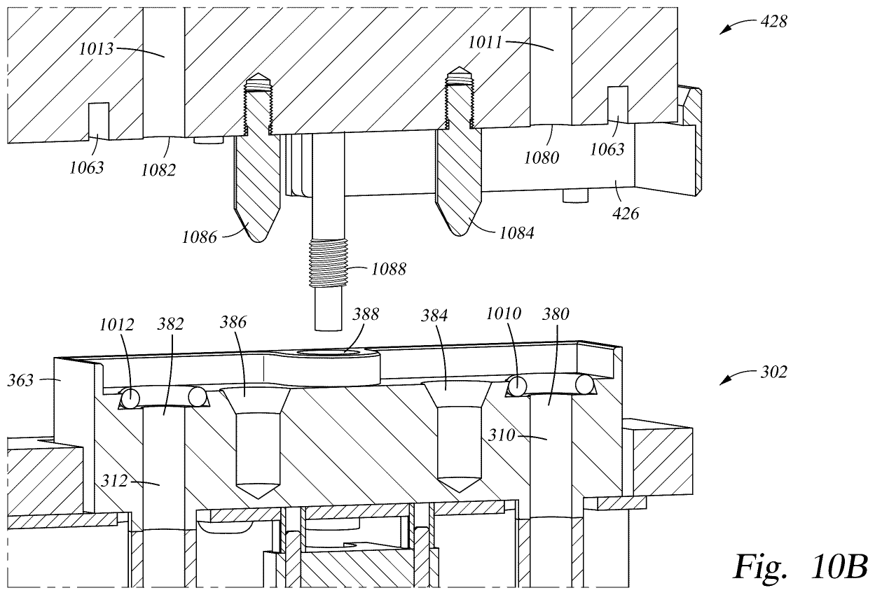

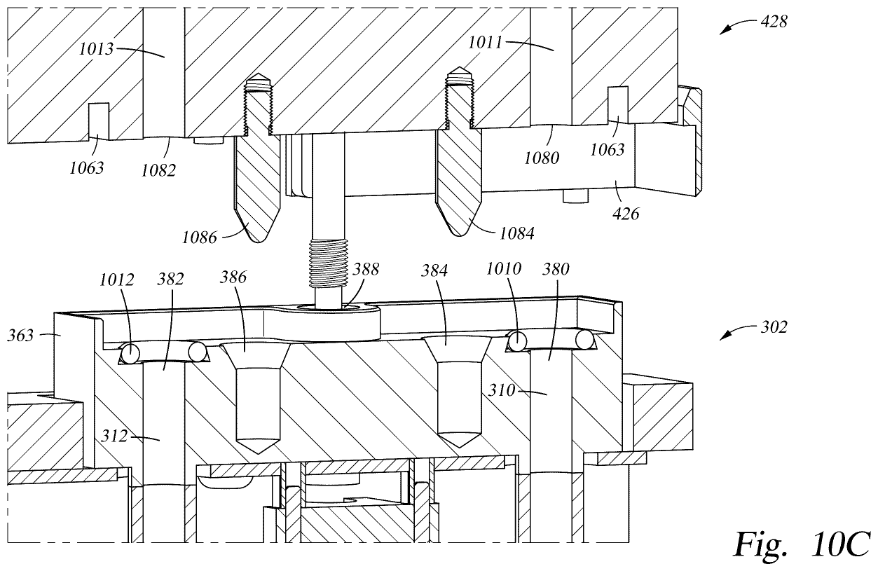

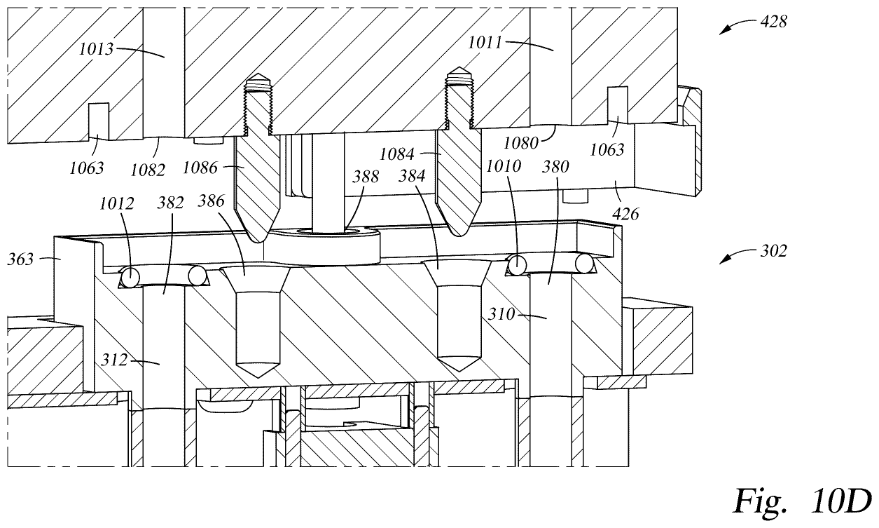

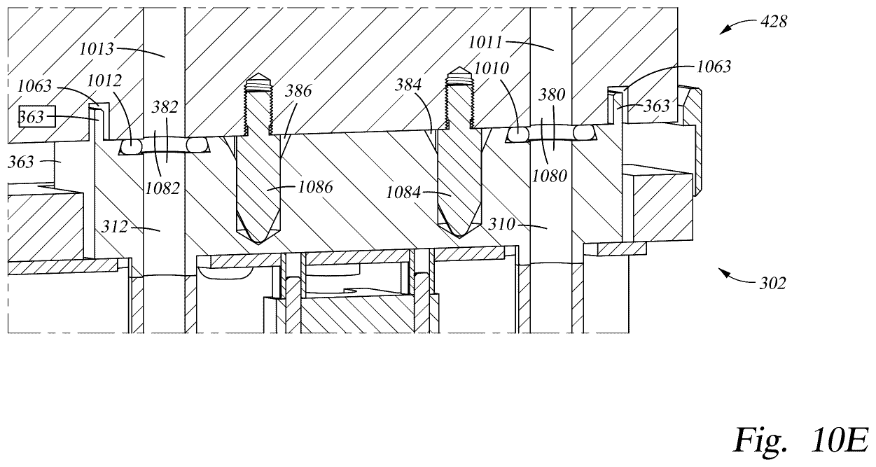

The end plate 362 provides structural support for electronic and fluid connections between the print tile 302 and supply assemblies that supply fluids, control and electricity to the print tile 302, such as a supply arrangement 428 described with respect to FIG. 4A. The end plate 362 has an electronics opening 390 for making electrical connection between the electronic interface member 360 and control circuitry (e.g., the controller 150) of the printer. Besides the fluid connectors 380, 382 described herein, the end plate 362 further comprises alignment holes 384, 386 and a threaded hole 388 for making a blind connection with the supply arrangement, as described with respect to FIGS. 10A-10E. A protection wall 363 is on the end plate 362 and extends around the fluid connectors 380, 382, alignment holes 384, 386 and threaded hole 388.

FIG. 4A is a partially disassembled top perspective view of the printhead assembly 126, according to one embodiment.

The printhead assembly 126 comprises a tile support structure 420 for holding the print tiles 302. The tile support structure 420 comprises a support plate 422 which allows for coupling of supply and return manifolds for print material to the print tiles 302. The support plate 422 includes a plurality of partitions 424 that guide positioning of the print material manifolds of each print tile and for positioning and engagement of electrical connections of the print tiles 302. The partitions 424 define therebetween furrows 434. The cage 329 positions the print tile 302 in one of the furrows 434, so the printheads of the tiles 302 are accurately positioned within the printhead assembly 126. The furrows 434 define the rows into which the tiles 302 are arranged.

The printhead assembly 126 further comprises a supply plate 426 oriented in substantially parallel arrangement with the support plate 422. Each print tile 302 extends substantially from the support plate 422 to the supply plate 426. A supply arrangement 428 is coupled to the supply plate 426 adjacent to each print tile 302 to supply liquid, gas, control, and electricity to the print tile 302. The case 329 of each print tile 302 extends from the support plate 422 to the supply plate 426 and provides structural containment and strength to the print tile 302, enabling handling of the print tile 302 as a unit. The supply arrangement 428 comprises valves 431 that control flow of print material into and out of each print tile 302. The valves 431 for each print tile 302 comprise at least a supply valve to control flow of print material into the print tile 302 and a return valve to control flow of print material out of the print tile 302.

An envelope 480 is disposed between the support plate 422 and the supply plate 426 for each print tile 302 to guide installation of the print tile 302 and connection of the print tile 302 (connections of the fluid connectors 380, 382 and the electrical interface member 460) with the supply arrangement 428. The print tile 302 is inserted through a print tile opening (not visible) in the support plate 422 into the envelope 480 to connect to the supply arrangement 428. In a region 411 schematically indicated in FIG. 4A, the supply plate 426 has one or more alignment structures (schematically illustrated at 484 in FIG. 4B) that protrude from the supply plate 426 to engage with corresponding alignment holes at the top of the cage 329, for example at the end plate 362, such that the various fluid and electrical connections of the print tile 302 connect securely as the print tile 302 is seated in the printhead assembly 126. The base plate 320 of the print tile 302 is attached to the support plate 422 to secure the print tile 302 within the printhead assembly 126. A detailed configuration of the region 411, where a blind connection between the print tile 302 and the supply arrangement 428 is made, will be described with respect to FIGS. 10A-10E.

FIG. 4B is a bottom perspective view of the partially disassembled printhead assembly of FIG. 4A, according to one embodiment.

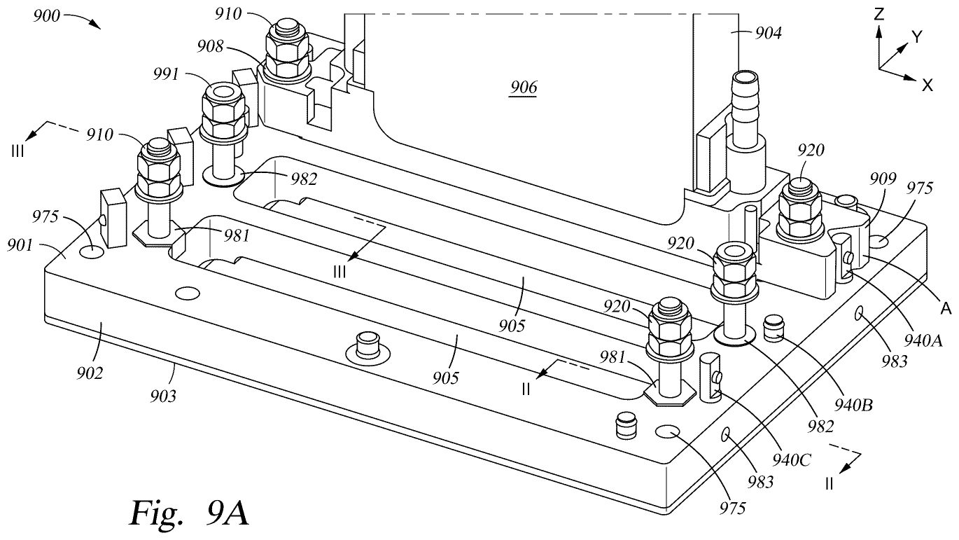

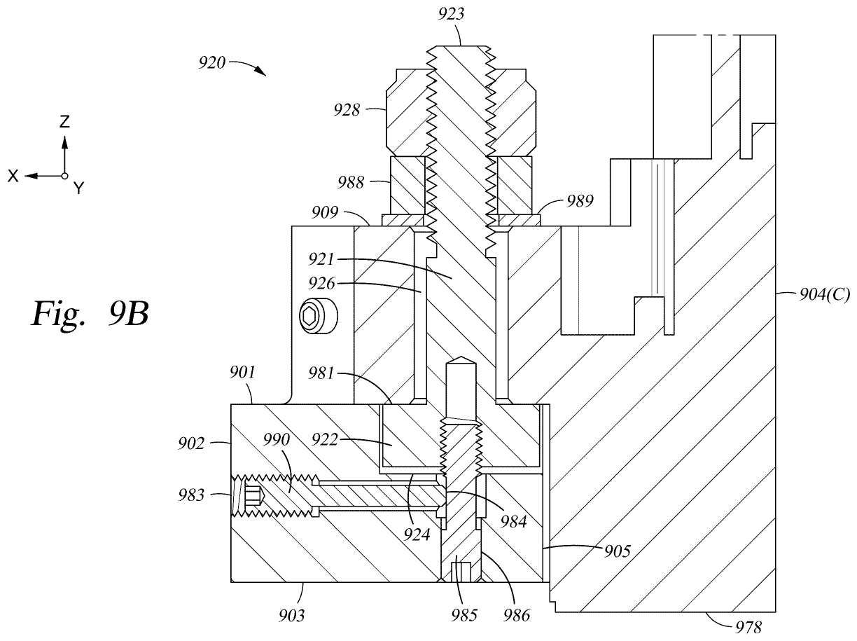

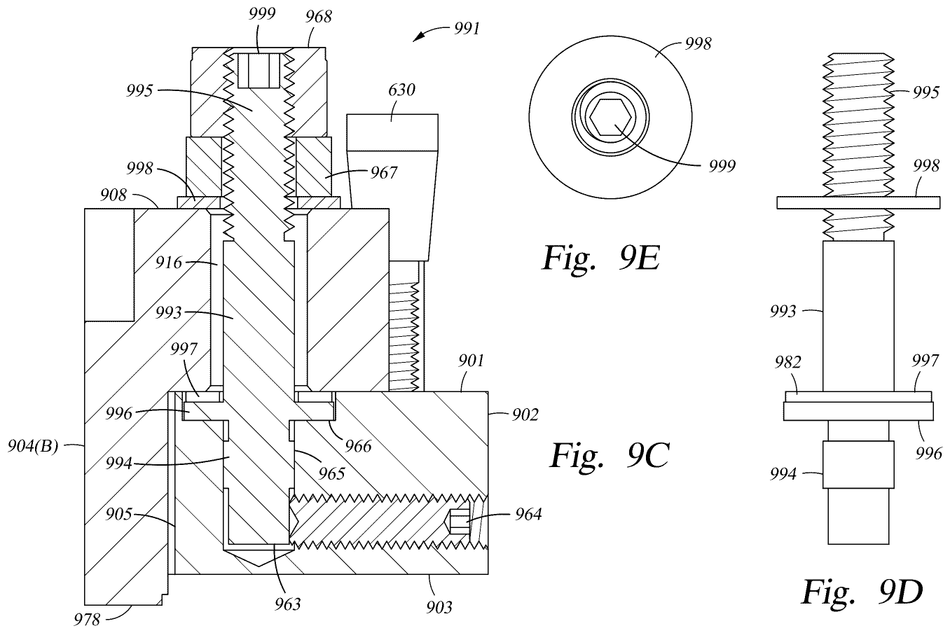

FIG. 4B shows the same view as FIG. 4A from the bottom. The print tile 302 is inserted through a tile opening 482 in the support plate 422 into the envelope 480 to connect to the supply arrangement 428. In the fully inserted state, an upper surface of the base plate 320, or base plate mounting pads on the upper surface, come in contact with a lower surface 483 of the support plate 422. The lower surface 483 of the support plate 422 defines a mounting plane common for the base plates of all print tiles 302, which facilitates at least the z-axis direction nozzle alignment across all printheads in the printhead assembly 126, as described with respect to FIGS. 5C-5E, 9A-9D. Other structures for defining a common mounting plane for multiple print tiles re within the scopes of various embodiments.

FIG. 5A is a partial, top perspective view of a bottom part of a print tile 500, according to one embodiment.

The print tile 500 comprises a base plate 502, and nozzle plates 504 attached to corresponding printheads 506 (only one printhead 506 corresponding nozzle plate B is designated in FIG. 5A). In some embodiments, the print tile 500 corresponds to the print tiles 202, 302, and includes further components as described with respect to FIG. 3. Other print tile configurations are within the scopes of various embodiments. In some embodiments, the base plate 502 corresponds to the base plate 320, and/or the printheads 506 correspond to the printheads 204, 304. The nozzle plates 504 are individually designated as nozzle plate A, nozzle plate B and nozzle plate C. Unless otherwise described, the nozzle plates 504 are configured similarly. The number of nozzle plates 504 and corresponding printheads 506 can be other than three. In FIG. 5A, the nozzle plate A is illustrated in the form of a wireframe and the corresponding printhead 506 is omitted to show features of other components.

The base plate 502 has an upper surface 501, a lower surface 503 opposite the upper surface 501 in a thickness direction (e.g., the z-axis direction) of the base plate 502, and a slot 505 extending through the base plate 502 from the upper surface 501 to the lower surface 503. The upper surface 501 is in the x-y plane. The slot 505 extends along the x-axis direction. The upper surface 501 of the base plate 502 further comprises attachment features 575, e.g., holes or posts, to be attached to strength members 350 of a case 329 as described with respect to FIG. 3.

Each nozzle plate 504 engages the upper surface 501 of the base plate 502, and is attached to the corresponding printhead 506. The printhead 506 has a lower part 507 (shown in FIG. 5C) received in the slot 505 and comprises a plurality of nozzles 577 (also shown in FIG. 5C) from which a print material is to be ejected in a printing operation, e.g., downward along the z-axis direction. The nozzle plates 504 are arranged side-by-side in the y-axis direction. Each nozzle plate 504 extends along the x-axis direction, and has opposite first end portion 508 and second end portion 509. The first end portion 508 and second end portion 509 of the nozzle plate 504 are arranged over the upper surface 501 of the base plate 502, and are configured for mounting the nozzle plate 504 on the base plate 502.

The print tile 500 further comprises a plurality of mounting elements to mount each nozzle plate 504 to the base plate 502, while permitting adjustment of a position of the nozzle plate 504 relative to the base plate 502. At least one direction in which the position of the nozzle plate 504 is adjustable may be any one or more translational directions along x-, y-, z-axes and/or any one or more rotational directions about the x-, y-, z-axes. The rotational directions about the x-, y-, z-axes are referred to herein as theta-x, theta-y, theta-z, respectively.

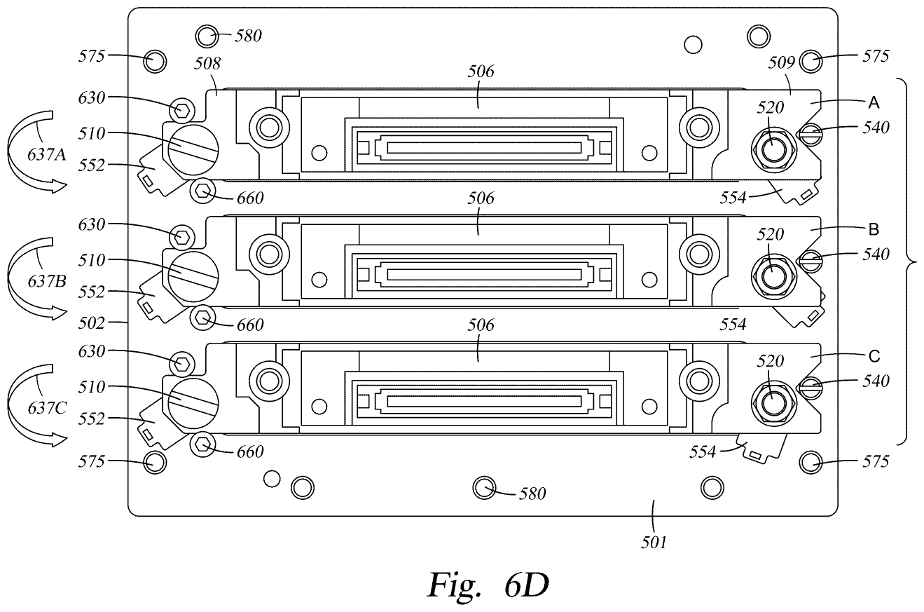

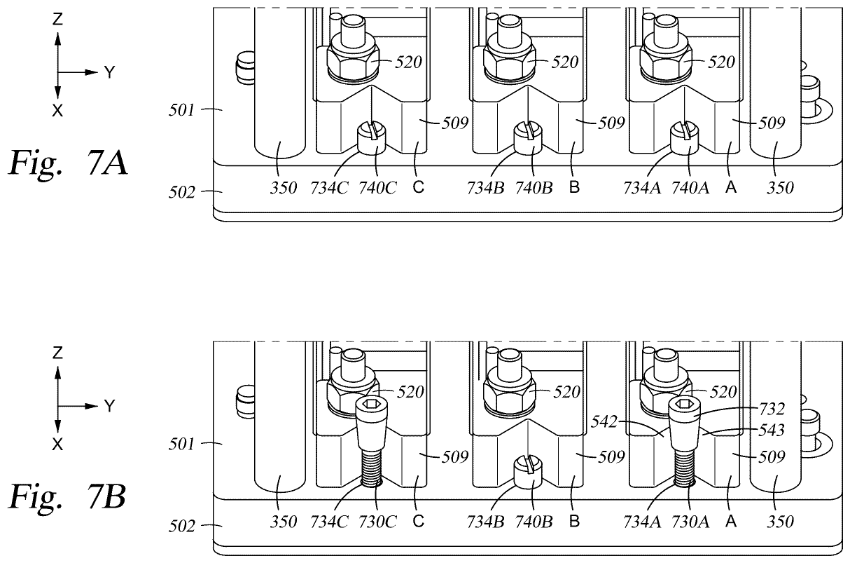

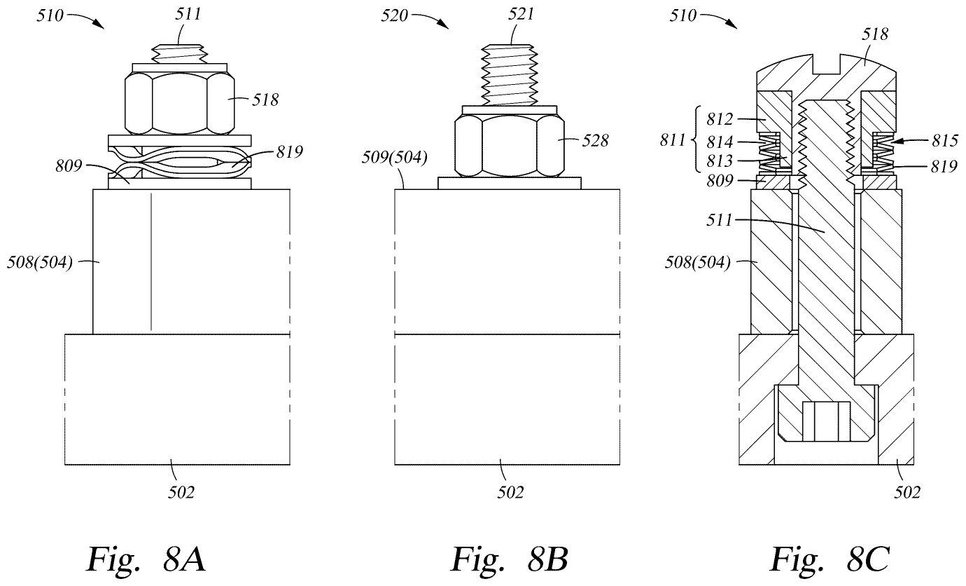

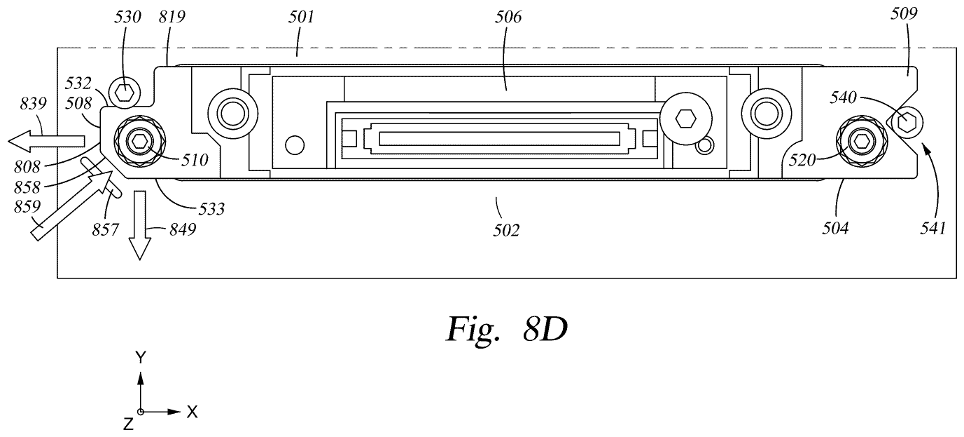

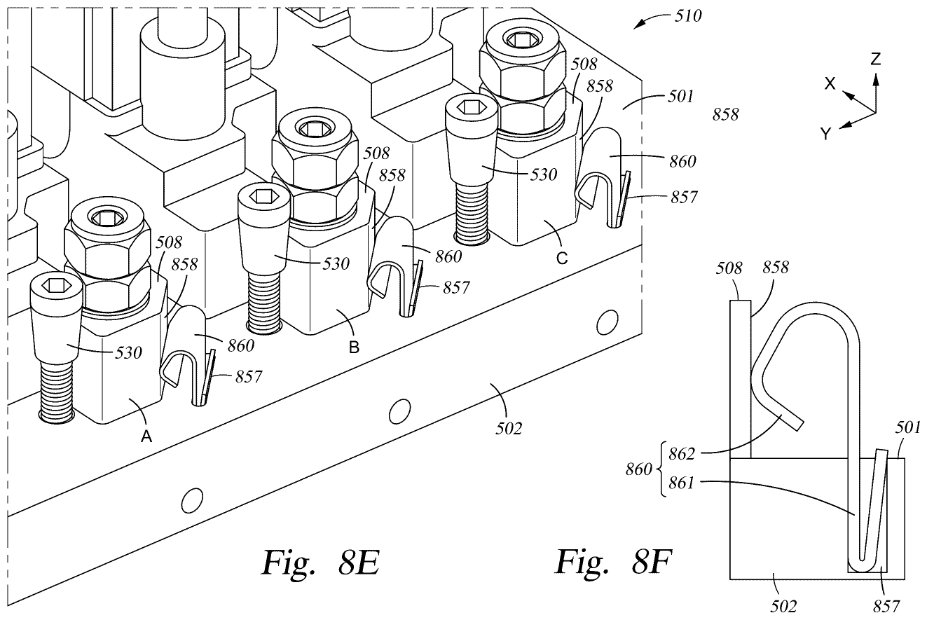

The plurality of mounting elements may comprise any one or more mounting elements described herein, depending on the direction(s) in which printhead adjustability is desirable. In an example, for z-axis adjustment, the plurality of mounting elements includes one or more spacers as described with respect to FIGS. 5C-5E, and/or one or more adjustable lifts as described with respect to FIGS. 9A-9D. In another example, for theta-z adjustment, the plurality of mounting elements includes one or more position adjusting elements as described with respect to FIGS. 6A-6D. In a further example, for x-axis and/or y-axis adjustment (also referred to as x-y adjustment), the plurality of mounting elements includes one or more position adjusting elements as described with respect to FIGS. 7A-7B. Where the x-y position of the printhead is to be fixed, without desirability or necessity for x-y adjustment, one or more of the position adjusting elements are correspondingly replaced with one or more position fixing elements, as also described with respect to FIGS. 7A-7B. In an additional example, the plurality of mounting elements permits thermal expansion of the printhead along a predetermined direction, as described with respect to FIGS. 8A-8F. The plurality of mounting elements for each printhead may be customized and/or configured differently from the plurality of mounting elements for another printhead on the same base plate. In other words, each printhead may be mounted and/or adjusted independently from other printheads on the same base plate, to achieve desirable nozzle alignment across multiple printheads. In some embodiments, a kit comprising multiple mounting elements of various, or all, types of mounting elements described herein is provided for each printhead, and an end-user may select from the kit one or more mounting elements of the required type(s) for mounting and/or adjusting the printhead on a base plate, depending on the actual direction(s) in which printhead position adjustment is desirable.

In the example configuration in FIG. 5A, the plurality of mounting elements for each printhead, e.g., for the nozzle plate A, comprises a first fastening element 510 and a second fastening element 520 correspondingly fastening the first end portion 508 and the second end portion 509 of the nozzle plate A to the base plate 502. Each of the first fastening element 510 and second fastening element 520 comprises a bolt or screw fastened to a nut to compress the base plate 502 and the nozzle plate A therebetween. Other fastener structures are within the scopes of various embodiments. Example configurations for the first fastening element 510 and/or the second fastening element 520 are described with respect to FIGS. 5C, 8A-8C, 9A-9D.

The plurality of mounting elements for each printhead, e.g., for the nozzle plate A, further comprises a position adjusting element 530 and an additional mounting element 540 for fixing and/or adjusting the position of nozzle plate A. Specifically, the position adjusting element 530 is arranged at the first end portion 508 of the nozzle plate A, to fix and adjust the position of the first end portion 508 in the x-y plane. The additional mounting element 540 is arranged at the second end portion 509 of the nozzle plate A, to fix and/or adjust the position of the second end portion 509 in the x-y plane. In situations where it is simply required to fix, without adjustability, the position of the second end portion 509 in the x-y plane, the additional mounting element 540 may be a position fixing element, e.g., a cylindrical post fixed, or a screw screwed, in the upper surface 501 of the base plate 502. In situations where it is required to both fix and adjust the position of the second end portion 509 in the x-y plane, the additional mounting element 540 may be a position adjusting element similar to the position adjusting element 530.

FIG. 5B is a top plan view of the nozzle plate A, the corresponding printhead 506 and a underlying portion of the base plate 502 of FIG. 5A, according to one embodiment.

As can be seen in FIG. 5B, the printhead 506 comprises a pair of an inlet and an outlet (both designated as 573) to be coupled to the corresponding conduits 373 (not shown in FIG. 5B) for supplying and returning the print material to and from the printhead 506. Also shown in FIG. 5B is an electrical connector 590 electrically coupled to the driver box 330 (not shown in FIG. 5B) to receive electricity and control signals to control the nozzles of the printhead 506 to eject the print material in a printing operation.

The first end portion 508 of the nozzle plate A comprises a cutout 531 recessed toward the first fastening element 510. The position adjusting element 530 is at least partially arranged in the cutout 531 and engages a side 532 of the first end portion 508 at the cutout 531. The side 532 of the first end portion 508 is located between the position adjusting element 530 and the first fastening element 510. In some embodiments, the cutout 531 is omitted.

The second end portion 509 of the nozzle plate A comprises a notch 541 having sidewalls 542, 543 converging toward each other in the longitudinal direction of the printhead 506 or nozzle plate A, i.e., in the x-axis direction, from the second end portion 509 to the first end portion 508. The additional mounting element 540 is at least partially arranged in the notch 541, and engages the sidewalls 542, 543 of the notch 541. The sidewall 542 of the notch 541 is located between the additional mounting element 540 and the second fastening element 520. The V-shape of the notch 541 as illustrated in FIG. 5B is an example. Other shapes of the notch 541 are within the scopes of various embodiments.

In the example configuration in FIG. 5B, the second end portion 509 further comprises a further cutout 561 in which an positioning pin 562 formed on the upper surface 501 of the base plate 502 is received. The further cutout 561 and the positioning pin 562 are used for initial alignment and/or positioning of the nozzle plate A on the upper surface 501, before fastening the nozzle plate A to the base plate 502 and/or adjusting the position of the nozzle plate A relative to the upper surface 501. A similar pair of a further cutout and a corresponding positioning pin may be provided at the first end portion 508. In some embodiments, the further cutout 561 and positioning pin 562 at the second end portion 509, and/or the similar pair of a further cutout and a positioning pin at the first end portion 508, is/are omitted.

The additional mounting element 540, which engages the sidewalls 542, 543 of the notch 541, at least fixes the position of the second end portion 509 in the longitudinal direction of the nozzle plate A, i.e., in the x-axis direction, and also in a transverse direction crossing the longitudinal direction, i.e., in the y-axis direction. When the additional mounting element 540 is a position adjusting element as described herein, the additional mounting element 540 further permits adjustment of the position of the second end portion 509, and the whole nozzle plate A, in the x-axis direction.

The additional mounting element 540 may still permit, to some degrees, a theta-z rotation, i.e., a rotation of the first end portion 508 about an axis oriented in the z-axis direction and passing through the additional mounting element 540 at the second end portion 509. Such a theta-z rotation may adversely affect parallelism of the printheads on the same base plate, i.e., may result in one printhead being non-parallel with the other printheads, which, in turn, may adversely affect nozzle alignment across multiple printheads. The position adjusting element 530, which engages the first end portion 508, makes it possible to adjust the position of the first end portion 508 in theta-z rotational direction. With the theta-z adjustment made possible by the position adjusting element 530, the intended parallelism of the printheads and nozzle alignment across multiple printheads is achievable. Further details of the position adjusting element 530 and/or the additional mounting element 540 are described with respect to FIGS. 6A-7B.

FIG. 5C is a schematic cross-sectional view taken along line I-I in FIG. 5A, according to one embodiment.

The schematic cross-sectional view in FIG. 5C shows example internal structures of the first fastening element 510 and position adjusting element 530. The first fastening element 510 comprises a bolt 511, a nut 518, and a washer 519. The bolt 511 extends in the z-axis direction, and has a head 512 at a lower end and threads 513 at an upper end thereof. The head 512 is received in a hole 514 extending from the lower surface 503 to the upper surface 501 of the base plate 502. An opening of the hole 514 on the lower surface 503 is larger than an opening of the hole 514 on the upper surface 501, resulting in a shoulder 515 which engages the head 512 of the bolt 511. The bolt 511 further extends through a hole 516 in the first end portion 508 to have the threads 513 exposed above an upper surface 517 of the first end portion 508. The nut 518 is fastened onto the threads 513, with the washer 519 interposed between the nut 518 and the upper surface 517 of the first end portion 508. The first end portion 508 and the base plate 502 are compressed in the z-axis direction between the nut 518 and the head 512 of the bolt 511. In some embodiments, the washer 519 is a wave washer as described with respect to FIG. 8A. In at least one embodiment, the washer 519 is a regular washer or another type of washer, or is omitted.

The second fastening element 520 is configured similarly to the first fastening element 510, and comprises a bolt 521 and a nut 528. The bolt 528 extends in the z-axis direction through corresponding holes 524, 526 in the base plate 502 and the second end portion 509 of the nozzle plate A, and has a head 522 at a lower end and threads (not numbered) at an upper end thereof. The nut 528 is fastened onto the threads of the bolt 521, with or without a washer interposed between the nut 528 and an upper surface (not numbered) of the second end portion 509. The second end portion 509 and the base plate 502 are compressed in the z-axis direction between the nut 528 and the head 522 of the bolt 521. The described bolt-and-nut configurations of the first fastening element 510 and second fastening element 520 are examples. Other fastening configurations are within the scopes of various embodiments.

As can be seen in FIG. 5C, the printhead 506 comprises an upper part above the upper surface 501 of the base plate 502, and the lower part 507 below the upper surface 501 and at least partially received in the slot 505. The lower part 507 comprises nozzles 577 which have openings or orifices on a lower surface of the lower part 507. This lower surface of the lower part 507 defines a nozzle plane 578. In some embodiments, it is desirable to mount the printheads on the same base plate so that the nozzle planes 578 of all printheads are coplanar. In at least one embodiment, the nozzle planes 578 are considered coplanar when the nozzle planes 578 are parallel and deviated from each other along the z-axis direction by a few microns, e.g., under 100 microns. Other criteria for defining coplanar nozzle planes are within the scopes of various embodiments.

In some embodiments, to ensure that the nozzle planes of the printheads on the same base plate are coplanar with each other, each printhead is mounted, using a corresponding plurality of mounting elements, so that the nozzle plane 578 of the printhead is parallel with a mounting plane of the base plate. For simplicity, the mounting plane is illustrated in FIG. 5C as corresponding to the upper surface 501 of the base plate 502. Other structures for defining the mounting plane are within the scopes of various embodiments, for example, as described with respect to FIG. 5D. A measuring device, e.g., a laser measuring device, is used to determine a first deviation of the nozzle plane 578 from the mounting plane at the side of the first end portion 508, and a second deviation of the nozzle plane 578 from the mounting plane at the side of the second end portion 509. If the first and second deviations are the same, or within a few microns of each other, the nozzle plane 578 is considered parallel with the upper surface 501. Otherwise, the nozzle plane 578 is considered non-parallel to the upper surface 501.

To make the nozzle plane 578 of the printhead 506 parallel with the mounting plane, one or more spacers having predetermined thicknesses are inserted between the upper surface 501 of the base plate 502 and at least one of the first end portion 508 or second end portion 509 of the nozzle plate A. This adjustment corresponds to theta-y adjustment, because the adjusted printhead is effectively rotated about an axis oriented along the y-axis direction. Specifically, on the side of the first end portion 508, one or more spacers schematically indicated as 552 are inserted between the first end portion 508 and the upper surface 501, and around the bolt 511. On the side of the second end portion 509, one or more spacers schematically indicated as 554 are inserted between the second end portion 509 and the upper surface 501, and around the bolt 521. In an example, if the nozzle plane 578 on the side of the first end portion 508 is further away from the mounting plane than on the side of the second end portion 509, then spacers 552 are selected to have a total thickness greater than a total thickness of the spacers 554. The number and/or thicknesses of the spacers 552, 554 are further selected so that the nozzle plane 578 of the printhead 506 is spaced from the mounting plane by substantially the same predetermined distance as the distance between the nozzle planes 578 of the other printheads and the same mounting plane of the same base plate 502, to make the nozzle planes 578 of all printheads coplanar, and spaced from the mounting plane by the same predetermined distance.

In an example, the spacers 552, 554 are selected from spacers having different predetermined thicknesses, such as 25.4 microns (0.001 inch), 38 microns (0.0015 inch), 50.8 microns (0.002 inch). By selecting one or more spacers of one or more of the described thickness, it is possible to achieve co-planarity to 12.5 microns (0.0005 inch) or lower. Other spacer thicknesses are within the scopes of various embodiments. In some embodiments, spacers are made of a metal, or other suitable materials.

As described with respect to FIG. 4B, all print tiles, when inserted and mounted in a printhead assembly, have the same, common mounting plane. By mounting printheads in each individual print tile to be coplanar and have the same predetermined distance to the mounting plane of the print tile, when the print tiles are mounted in a printhead assembly with a common mounting plane, the printheads across all print tiles are coplanar, which makes it possible to achieve advantages such as easy control, high printing quality, or the like.

FIG. 5D is a top plan view of the nozzle plates 504, the printheads 506, and the base plate 502 of FIG. 5A, with interposing spacers 552, 554, according to one embodiment.

In the example configuration in FIG. 5D, spacers 552, 554 are inserted at all end portions of all nozzle plates A, B, C. However, there are situations where no spacers are inserted at least at one end portion of at least one nozzle plate.

As can be seen in FIG. 5D, the base plate 502 further comprises on the upper surface 501, base plate mounting pads 580 which come into contact with a support structure in a printhead assembly, for example, as described with respect to FIG. 4B. The base plate mounting pads 580 define the mounting plane of the base plate 502 in this configuration. In some embodiments, the base plate mounting pads 580 are omitted and the mounting plane of the base plate 502 corresponds to the upper surface 501. Other structures for defining the mounting plane of the base plate 502 are within the scopes of various embodiments.

FIG. 5D further shows biasing elements 560 each at the first end portion 508 of one of the nozzle plates 504. For example, the biasing element 560 corresponding to the nozzle plate A engages a side 533 of the first end portion 508 of the nozzle plate A. The side 533 is opposite, in the y-axis direction, to the side 532 engaged by the position adjusting element 530. The first fastening element 510 is arranged between the position adjusting element 530 and the biasing element 560. The biasing element 560 elastically biases the first end portion 508 of the nozzle plate A toward the position adjusting element 530. In some embodiments, the biasing element 560 comprises a spring pushing against the side 533. Other structures for pushing against the side 533 are within the scopes of various embodiments. The biasing element 560 permits thermal expansion of the first end portion 508 of the nozzle plate A, due to an excursion in temperature, in the y-axis direction or theta-z direction. When the temperature returns to ambient, or nominal, temperature, the biasing element 560 returns the first end portion 508 to the same position, thereby ensuring nozzle alignment across the printheads and/or print tiles. The biasing element 560 corresponding to the other nozzle plates B, C operate in a similar manner.

FIG. 5E is a top perspective view of a spacer 564, according to one embodiment. The spacer 564 in FIG. 5E is an example of one or more spacers 552, 554 described with respect to FIGS. 5C-5D.

The spacer 564 comprises a main body 565 which has a curved cutout 566 at one end, and a handling part 567 at the opposite end. The cutout 566 extends around the corresponding bolt 511 or bolt 521 when the spacer 564 is inserted between the base plate 502 and the corresponding first end portion 508 or second end portion 509 of a nozzle plate. The handling part 567 is configured to facilitate handling, e.g., inserting or removal, of the spacer 564 between a nozzle plate and the corresponding base plate. The described spacer configuration is an example. Other spacer configurations are within the scopes of various embodiments.

FIG. 6A is a side view of a conical screw 630, according to one embodiment. FIG. 6B is a perspective view of an end portion 508 of a nozzle plate 504, with the conical screw 630 of FIG. 6A. FIG. 6C is a perspective view similar to FIG. 6B, showing the operation of the conical screw 630 of FIG. 6A. The conical screw 630 is an example of the position adjusting element 530. In some embodiments, the conical screw 630 is also usable as the additional mounting element 540.

As shown in FIG. 6A, the conical screw 630 comprises a head 631, a conical part or conical surface 632, and threads 633 arranged in the described order. The head 631 is configured to be engaged with a tool for turning the conical screw 630. The conical surface 632 gradually tapers from the head 631 toward the threads 633.

As shown in FIG. 6B, the conical screw 630 is mounted onto the base plate 502 by engaging the threads 633 in a threaded hole 634 on the upper surface 501. The conical surface 632 engages the side 532 of the first end portion 508 of the nozzle plate 504.

As shown in FIG. 60, when the conical screw 630 is driven, e.g., by a tool engaging with the head 631, to go deeper into the threaded hole 634, the conical surface 632 pushes the first end portion 508 further to the right side along the y-axis direction, as illustrated by the arrow head 635. When the conical screw 630 is driven in the direction to loosen it from the threaded hole 634, the conical surface 632 permits the first end portion 508 to return to the left side along the y-axis direction, as illustrated by the arrow head 636. The first end portion 508 of the nozzle plate 504 may return due to the material property of the nozzle plate 504, and/or due to a biasing element 560 (not shown in FIG. 6C). In an example configuration, a quarter (¼) turn of the conical screw 630 causes the first end portion 508 of the nozzle plate 504 to move about 10 microns. Other configurations are within the scopes of various embodiments.

FIG. 6D is a top plan view of nozzle plates 504, printheads 506 and a base plate 502, with conical screws 630, according to one embodiment.

As shown in FIG. 6D, a conical screw 630 engages the first end portion 508 of the nozzle plate A, to perform theta-z adjustment of the nozzle plate A in a rotational direction about the second end portion 509, in the manner described with respect to position adjusting element 530 in FIGS. 5B, 5D. Specifically, as the conical screw 630 is driven into the upper surface 501 of the base plate 502, the nozzle plate A is pushed by the conical screw 630 to rotate about the corresponding additional mounting element 540, as shown by the arrow 637A. Driving the conical screw 630 in a direction to loosen it from the upper surface 501 permits the first end portion 508 to rotate in the opposite direction to the arrow 637A. The conical screws 630 for the other nozzle plates B, C are operated in similar manners, to perform theta-z adjustments for the nozzle plates B, C, as shown by corresponding arrows 637B, 637C. The theta-z adjustment of each printhead is performed independently from the other printheads. As a result, it is possible to adjust the nozzle plates A, B, C and the corresponding printheads 506 to be parallel to each other, i.e., to achieve parallelism of the printheads 506. Therefore, rows and/or columns of nozzles of the printheads can be adjusted to be parallel to each other across multiple print tiles in a printhead assembly, resulting in one or more advantages described herein, e.g., easy control, high printing quality. In some embodiments, parallelism of the printheads is verified by a camera that captures an image of the printheads for image processing by a processor to determine the amount and direction of theta-z adjustment to be made for each printhead.

FIG. 6D further shows additional mounting elements 660 each for one of the nozzle plates A, B, C. Specifically, the additional mounting element 660 corresponding to the nozzle plate A is arranged in a location similar to the biasing element 560 described with respect to FIG. 5D. In some embodiments, the additional mounting element 660 is the same as the biasing element 560, and biases the nozzle plate A toward the corresponding conical screw 630. In further embodiments, the additional mounting element 660 defines a limit for the theta-z adjustment of the nozzle plate A. In such embodiments, the additional mounting element 660 is configured similar to the additional mounting element 540 as described herein. Additionally or alternatively, the additional mounting element 660 also sets a rigidity of the nozzle plate fastening, and/or how much room there is for thermal expansion.

FIG. 7A is a perspective view of second end portions 509 of nozzle plates A, B, C on a base plate 502, with position fixing elements 740A-740C, according to one embodiment. FIG. 7B is a perspective view similar to FIG. 7A, with position adjusting elements 730A, 730C, and a position fixing element 740B, according to one embodiment.

In FIG. 7A, each of the position fixing elements 740A-740C is arranged in and engages sidewalls of a notch in the corresponding nozzle plate, as described with respect to additional mounting element 540 in FIGS. 5B, 5D. The position fixing elements 740A-740C are arranged to fix the position of the corresponding printheads along the x-axis direction; however, the position fixing elements 740A-740C are not configured to permit adjustment of the position of the corresponding printheads along the x-axis direction. The position fixing elements 740A-740C may be cylindrical posts formed integrally with, or irremovably from, the upper surface 501 of the base plate 502.

In the example configuration in FIG. 7A, each of the position fixing elements 740A-740C has an upper cylindrical part and a lower part with threads (not shown), and is removably screwed in corresponding threaded holes 734A-734C formed in the upper surface 501 of the base plate 502. This configuration permits one or more of the position fixing elements 740A-740C to be removed and replaced with corresponding one or more position adjusting elements, such as conical screws, to provide position adjustability if desirable.

FIG. 7B shows an example configuration where the position fixing elements 740A and 740C in FIG. 7A are removed (unscrewed) from the corresponding threaded holes 734A and 734C, and replaced with corresponding conical screws 730A and 730C which are screwed into the threaded holes 734A and 734C. The conical screws 730A and 730C are configured and operate similarly to the conical screw 630. For example, the conical screw 734A has a conical surface 732 engaging sidewalls 542, 543 of a notch in the second end portion 509 of the nozzle plate A. When the conical screw 734A is driven to go deeper into the base plate 502, the conical surface 732 pushes against the sidewalls 542, 543, and cause the nozzle plate A to move along the x-axis direction toward the first end portion 508. The further conical screw 734A is driven into the base plate 502, the further the nozzle plate A is move along the x-axis direction away from the conical screw 734A. As a result, it is possible to adjust, and fix, the position of the nozzle plate A and the corresponding printhead 506 in the x-axis direction, by using the conical screw 734A. The conical screw 734C is operated in a similar manner. The described configuration in FIG. 7B is an example. Any one or more of the position fixing elements 740A-740C is replaceable with corresponding position adjusting elements, e.g., conical screws.

In an example alignment process, the position fixing elements 740A-740C are initially deployed, e.g., by default, on the base plate 502. In this initial configuration, the x-axis position accuracy depends on machining and printhead tolerances. In some situations, machining tolerances are within 100 microns, and printhead tolerances are further added on top of machining tolerances. If acceptable x-axis position accuracy can be achieved by the position fixing elements 740A-740C, no conical screws will be needed. If it is determined that better x-axis position accuracy is needed, one or more of the position fixing elements 740A-740C are replaced with corresponding conical screws for x-axis direction adjustability. As described herein in a specific example, a quarter turn of a conical screw can make an adjustment of about 10 microns which is smaller than machining and printhead tolerances in many situations. Thus, it is possible to improve x-axis position accuracy for each printhead, and nozzle alignment across multiple printheads and/or print tiles for the whole printhead assembly.

FIGS. 8A and 8B are side views of a first fastening element 510 and a second fastening element 520, respectively, for fastening opposite first end portion 508 and second end portion 509 of a nozzle plate 504 to a base plate 502, according to one embodiment.

The first fastening element 510 in FIG. 8A is as described with respect to FIG. 5C, with an additional feature that the washer 519 in FIG. 5C is configured as a wave washer 819 in FIG. 8A. A washer 809 is arranged between the wave washer 819 and the nozzle plate 504. In some embodiments, a material of the washer 809 is PEEK (Polyetheretherketone) to permit the nozzle plate 504 to slide due to thermal expansion while secured. The torque of the nut 518 is controlled so that the wave washer 819 secures the nozzle plate 504 while permitting sliding, due to thermal expansion, of the nozzle plate 504 along the x-axis direction, as described with respect to FIG. 8D. The second fastening element 520 in FIG. 8B is as described with respect to FIG. 5C.

FIG. 8C is a cross-sectional view of the fastening element 510, in an alternative embodiment. Compared to FIG. 8A, the fastening element 510 in the alternative embodiment in FIG. 8C additionally includes a spacer 811 between the nut 518 (which is a barrel screw in this example embodiment) and the wave washer 819. The spacer 811 has an upper part 812 and a lower part 813. The lower part 813 has a reduced thickness in the radial direction compared to the upper part 812, resulting in a recessed region 814 in which a lower portion of the wave washer 819 is received. The upper part 812 comprises a slot 815 in which an upper end of the wave washer 819 is received. As a result, the wave washer 819 is kept centered around the bolt 511 and is prevented from moving laterally in the radial direction, when the barrel screw 518 is screwed downward to compress the wave washer 819. The compression force of the wave washer 819 is selected to fasten the first end portion 508 of the nozzle plate 504 to the base plate 502 in alignment with the other nozzle plates/printheads, while still permitting thermal expansion of the first end portion 508 as described herein. In some embodiments, the lower part 813 of the spacer 811 is omitted.

FIG. 8D is a top plan view of a nozzle plate 504, a printhead 506 and a portion of a base plate 502, according to one embodiment.

The first end portion 508 and the second end portion 509 of the nozzle plate 504 are fastened to the base plate 502 correspondingly by the first fastening element 510 and the second fastening element 520 as described with respect to one or more of FIGS. 8A-8C. The position of the second end portion 509 is fixed in the x-axis direction by the additional mounting element 540 engaging the sidewalls of the notch 541, as described with respect to FIG. 5B. Along the x-axis direction, i.e., along the longitudinal direction of the nozzle plate 504, the nozzle plate 504 has an end 808 that is opposite to the notch 541. There is no mounting element or another feature that engages or contacts the end 808 in the x-axis direction. As result, the nozzle plate 504 is free to expand thermally along the x-axis direction, i.e., along the longitudinal direction of the nozzle plate 504, away from the notch 541, as indicated by the arrow 839. This thermal expansion of the nozzle plate 504 is further facilitated by the wave washer 819, as described with respect to FIGS. 8A, 8C.

In the y-axis direction or theta-z direction, the first end portion 508 engages, at the side 532, the position adjusting element 530, as described with respect to FIG. 5B. Thus, the first end portion 508 is prevented by the position adjusting element 530 from thermally expand on the side 532. The first end portion 508 is, however, permitted to thermally expand on the opposite side 533, in a direction away from the position adjusting element 530, as indicated by the arrow 849. In some embodiments, a biasing element 560 is provided to engage the side 533, as described with respect to FIG. 5D. The biasing element 560 still permits the first end portion 508 to thermally expand away from the position adjusting element 530 due to an excursion in temperature. The biasing element 560 acts to return the first end portion 508 to the initial position when the temperature returns to ambient, or nominal, temperature, thereby ensuring nozzle alignment across the printheads and/or print tiles. Thus, although there may be a concern that thermal expansion of the nozzle plate 504 may affect nozzle alignment, such concern can be alleviated by the described configuration, which permits the nozzle plate to thermally expand in various directions.

In an alternative embodiment, instead of the biasing element 560, a biasing element 860 (with an example configuration described with respect to FIGS. 8E-8F) is provided to engage a slanted side 858 that connects the sides 808, 533 of the first end portion 508. In the example configuration described herein, the biasing element 560 is installed in a slot 857 in the upper surface 501 of the base plate 502. The biasing element 860 exerts a resilient force in a direction of arrow 859. The biasing element 860 permits the first end portion 508 to thermally expand away from the position adjusting element 530 along both the x-axis direction and the y-axis direction (as shown by arrows 839, 849), and acts to return the first end portion 508 to the initial position along both the x-axis direction and the y-axis direction when the temperature returns to ambient, or nominal, temperature. One or more advantages described herein with respect to the biasing element 560 are achievable by the biasing element 860.

FIG. 8E is a partial, top perspective view of a bottom part of a print tile, showing biasing elements 860 for nozzle plates A-C, according to one embodiment. FIG. 8F is a partial cross-sectional view of a biasing element 860 in FIG. 8E, according to one embodiment. The biasing element 860 for nozzle plate C is described herein. The biasing elements 860 for nozzle plates A-B are similarly configured. As described with respect to FIG. 8D and illustrated in FIG. 8E, the biasing element 860 is installed in the slot 857 in the upper surface 501 of the base plate 502, and resiliently engages the slanted side 858 of the first end portion 508 of the nozzle plate C. In FIG. 8F, the biasing element 860 is a spring clip, e.g., a type of a Tinnerman clip. The biasing element 860 comprises a lower part 861 fitted by its spring force in the slot 857, and an upper part 862 resiliently engaging the slanted side 858 of the first end portion 508.

FIG. 9A is a partial, top perspective view of a bottom part of a print tile 900, showing a base plate and printheads, according to one embodiment. FIG. 9B is a schematic cross-sectional view taken along line II-II in FIG. 9A. FIG. 9C is a schematic cross-sectional view taken along line III-III in FIG. 9A. FIG. 9D includes a side view and a top view of a mounting element in FIG. 9C, according to one embodiment. In some embodiments, the print tile 900 corresponds to one or more of the print tiles 202, 302, 500 described herein. Components of FIGS. 9A-9D having corresponding components in FIGS. 5A-5E are designated with the reference numerals in FIGS. 5A-5E increased by four hundred.

In FIG. 9A, the print tile 900 comprises a base plate 902, printheads 906 and nozzle plates 904. In some embodiments, the print tile 900 includes further components as described with respect to FIG. 3. Other print tile configurations are within the scopes of various embodiments. Like nozzle plates 504, the nozzle plates 904 are individually designated as nozzle plate A, nozzle plate B and nozzle plate C. Unless otherwise described, the nozzle plates 904 are configured similarly. The number of printheads 906 and corresponding nozzle plates 904 can be other than three. In FIG. 9A, the nozzle plates B, C and the corresponding printheads 906 are omitted to show features of other components. The base plate 902 has an upper surface 901, a lower surface 903 opposite the upper surface 901 in a thickness direction (e.g., the z-axis direction) of the base plate 902, and a plurality of slots 905 extending through the base plate 902 from the upper surface 901 to the lower surface 903. in FIG. 9A, the slot 905 for nozzle plate A is not visible. The upper surface 901 of the base plate 902 further comprises attachment features 975, e.g., holes or posts, to be attached to strength members 350 of a case 329 as described with respect to FIG. 3. The nozzle plates 904 are attached to the corresponding printheads 506 and are arranged side-by-side in the y-axis direction. Each nozzle plate 904 extends along the x-axis direction, and has opposite first end portion 908 and second end portion 909. FIG. 9A also shows additional mounting elements 940A, 940B, 940C for the nozzle plates A, B, C. Each of the additional mounting elements 940A, 940B, 940C corresponds to any of the additional mounting element 540, conical screws 630, 730A, 730C, or position fixing elements 740A-740C.

A difference between the print tile 500 and the print tile 900 is that a structure for z-axis adjustment and/or theta-y adjustment is built in the base plate 902. Specifically, the first end portion 908 and second end portion 909 of each of outside nozzle plates A and C are arranged on corresponding adjustable lifts 981, and are fastened to the base plate 902 by corresponding first fastening element 910 and second fastening element 920. An example configuration of the second fastening element 920 and the corresponding adjustable lift 981 is described with respect to FIG. 9B. A hole 983 for accessing a locking set screw in the second fastening element 920 is also illustrated in FIG. 9A for each of the nozzle plates A and C. An example configuration of the first fastening element 991 and the corresponding raised pad 982 is described with respect to FIGS. 9C-9D.

In some embodiments, the raised pads 982 under first and second end portions of the nozzle plate B are fixed, and the height of the raised pad 982 is not adjustable. In other embodiments as described with respect to FIGS. 9C-9D, the height of at least one raised pad 982 is adjustable. In an example, the raised pads 982 are at about 50 microns above the upper surface 901 of the base plate 902, and the nozzle plate B defines a plane to which the nozzle plates A and C are aligned. The adjustable lifts 981 under the first and second end portions of each of the nozzle plates A and C are adjusted, independently from each other and from the other nozzle plate, to make the nozzle planes of the printheads attached to nozzle plates A and C coplanar with the nozzle plane of the printhead attached to nozzle plate B. The described configuration is an example. Other configurations are within the scopes of various embodiments. For example, the raised pads 982 may be raised at a height other than 50 microns, relative to the upper surface 901 of the base plate 902.

FIG. 9B is a schematic cross-sectional view taken along line II-II in FIG. 9A, showing an example structure of the second fastening element 920 that fastens the second end portion 909 of the nozzle plate C to the base plate 902. In some embodiments, the first fastening element 910 that fastens the first end portion 908 of the nozzle plate C to the base plate 902 has the same configuration as the second fastening element 920.

The second fastening element 920 comprises a bolt 921, a nut 928, a differential screw 985, and a locking set screw 990. The bolt 921 extends in the z-axis direction, and has a head 922 at a lower end and threads 923 at an upper end thereof. The head 922 is received in a hole 924 in the base plate 902. The bolt 921 extends from the head 922, through a hole 926 in the second end portion 909 of the nozzle plate C, and has the threads 923 extending beyond the second end portion 909 to be received in a spacer 988 and a washer 989, and engaged with the nut 928. An upper surface of the head 922 defines the adjustable lift 981. The second end portion 909 is tightly compressed between the nut 928 and the adjustable lift 981. When the adjustable lift 981 is raised by operating the differential screw 985 as described herein, the second end portion 909 is raised together with the adjustable lift 981, resulting in z-axis and/or theta-y adjustment.

The differential screw 985 is received in a hole with an opening on the lower surface 903 of the base plate 902. The differential screw 985 has first threads 986 engaged with corresponding threads in the hole of the base plate 902, and second threads 987 engaged with corresponding threads in the head 922 of the bolt 921. A first thread pitch Pitch1 of the first threads 986 is different from a second thread pitch Pitch2 of the second threads 987. The effective pitch of the differential screw 985 is equal to Pitch1 minus Pitch 2. When the differential screw 985 is turned, e.g., clockwise, the adjustable lift 981 is raised by an amount corresponding to the amount of the turning and the effective pitch. In an example, the first threads 986 have a diameter of 3 mm and first thread pitch Pitch1 of 0.5 mm, the second threads 987 have a diameter of 2.5 mm and second thread pitch Pitch2 of 0.45 mm, and one revolution of the differential screw 985 raises the adjustable lift 981 and the second end portion 909 of the nozzle plate C by 50 microns. A quarter turn raises or lowers the second end portion 909 of the nozzle plate C by 12.5 microns. This configuration makes it possible to get all nozzle planes 978 coplanar within a few microns. When co-planarity has been achieved, the locking set screw 990, accessible through the hole 983, is operated to come into contact 984 with the differential screw 985 to lock the differential screw 985 at the adjusted position. The described specific thread pitches and/or dimensions are examples. Other configurations are within the scopes of various embodiments. For example, by varying Pitch1 and Pitch 2, it is possible to obtain a smaller effective pitch of the differential screw 985 which, in turn, allows a smaller adjustment amount per revolution of the differential screw 985.

FIG. 9C is a schematic cross-sectional view taken along line III-III in FIG. 9A, showing an example structure of the first fastening element 991 that fastens the first end portion 908 of the nozzle plate B to the base plate 902. The second fastening element 992 that fastens the second end portion 909 of the nozzle plate B to the base plate 902 has the same configuration as the first fastening element 991.

The first fastening element 991 comprises a bolt 993, a nut 968, and a locking set screw 964. The bolt 993 is shown in a side view and a top view in FIG. 9D. As shown in FIG. 9D, the bolt 993 comprises first threads 994 at a lower end, second threads 995 at an upper end, and a support 996 between the first threads 994 and the second threads 995. A washer 997 is placed around the bolt 993 and on the support 996. An upper surface of the washer 997 defines the raised pad 982. In some embodiments, the washer 997 is omitted and the support 996 itself defines the raised pad 982. A further washer 998 is also placed around the second threads 995 of the bolt 993. In some embodiments, a material of one or more of the washers 989, 997 998 is PEEK to permit sliding of the corresponding nozzle plate due to thermal expansion. Other washer materials are within the scopes of various embodiments. The top view in FIG. 9D shows an engagement part 999 at the top of the bolt 993. The engagement part 999 is to be engaged by a tool to rotate the bolt 993 to adjust a height of the raised pad 982.

As shown in FIG. 9C, the bolt 993 is received in a blind hole 963 which has an enlarged portion 997 toward the upper surface 901 of the base plate 902. The enlarged portion 997 forms a flange 966. The first threads 994 of the bolt 993 are engaged with corresponding threads in the hole 963 of the base plate 902. The washer 997 on the support 996 projects in the z-axis direction above the upper surface 901 of the base plate 902 to form the raised pad 982. The bolt 993 further extends in the z-axis direction into and then beyond the hole 916 in the first end portion 908, and has the second threads 995 extending beyond the first end portion 908. The washer 998 and spacer 967 are placed around the second threads 995 which are fastened to the nut 968. The first end portion 908 of the nozzle plate is compressed between the washer 998 under the nut 968 and the washer 997 on the support 996. The torque of the nut 968 is controlled so that the nozzle plate is secured between the washers 998, 997, without preventing sliding, due to thermal expansion, of the nozzle plate.

The raised height of the raised pad 982 in the z-axis direction is customizable by the thickness of the washer 997, and/or how deep the bolt 993 is screwed into the hole 963. The support 996 may rest on the flange 966 as the bolt 993 is fastened into the hole 963. The position where the support 996 rests on the flange 966 corresponds to the lowest possible height of the raised pad 982. The bolt 993 may be set at a position where the support 996 does not rest on the flange 966. In an example, the first threads 994 of the bolt 993 have a diameter of 4 mm and a thread pitch of 0.25 mm, and one revolution of the bolt 993 raises or lowers the support 996, the raised pad 982 and the first end portion 908 of the nozzle plate by 250 microns. When a desired height of the raised pad 982 has been achieved, the locking set screw 964 accessible through a hole (not numbered) on a side of the base plate 502 is operated to come into contact with the bolt 993 to lock the bolt 993, and therefore, the corresponding raised pad 982 at the desired raised height. The described specific thread pitch and/or dimension are examples. Other configurations are within the scopes of various embodiments.

In an example configuration, an adjustable raised pad 982 as described with respect to FIGS. 9C-9D is placed under each of first and second end portions of each nozzle plate. The height of each raised pad 982 is adjusted independently from the other raised pads 982 by rotating the bolt 993 with a tool engaging the engagement part 999 thereof. The adjustments are made so that nozzle planes of the printheads become coplanar, or substantially coplanar with a tolerance of 50 microns or smaller. Once co-planarity has been achieved, the corresponding locking set screws 964 are operated to lock the raised pads 982 and to keep the achieved coplanar state of the nozzle planes. In an alternative configuration, an adjustable lift 981 as described with respect to FIG. 9B is placed under each of first and second end portions of each nozzle plate. In another configuration one or more adjustable lifts 981 and one or more raised pads 982, which may be fixed or adjustable, are used together in the same print tile for printhead and/or nozzle alignment.

In an example process for printhead and/or nozzle alignment in a print tile, z-axis and/or theta-y adjustments are first performed to obtain co-planarity of the nozzle planes, by using spacers and/or adjustable lifts and/or raised pads, as described with respect to FIGS. 5C-5E, 9A-9D. Subsequently, theta-z adjustments are performed to obtain parallelism of the printheads, by using position adjusting elements or conical screws, as described with respect to FIGS. 5B, 5D, 6A-6D. Further, x-axis adjustments are performed as needed, by using position adjusting elements or conical screws, as described with respect to FIGS. 7A-7B. The fastening elements are fastened to keep the obtained nozzle plane co-planarity, printhead parallelism and/or printhead x-axis accuracy. In some embodiments, the fastened printheads are permitted to thermally expand at least at one end portion, as described with respect to FIGS. 8A-8F. As a result, temperature fluctuations during operation may not significantly affect the obtained printhead and/or nozzle alignment. The described order in which specific adjustments are to be made is just an example. Other order of adjustments in one or more of the described six directions (i.e., x-, y-, z-axes, theta-x, theta-y, theta-z) are within the scopes of various embodiments.

When the printheads and/or nozzles in each of a plurality of print tiles are properly aligned as described, the obtained printhead and/or nozzle alignment may be preserved across the whole printhead assembly when the titles are assembled in the printhead assembly with a common mounting plane, as described with respect to FIG. 4B.

FIG. 10A is a perspective view of a top part of a print tile 302 and a corresponding connector part of a supply arrangement 428 to be coupled to the print tile 302, according to one embodiment. FIGS. 10B-10E are schematic cross-sectional views showing various states while the top part of the print tile 302 and the corresponding connector part of the supply arrangement 428 are being coupled together. The structure and/or connection described with respect to FIGS. 10A-10E corresponds to the region 411 in FIG. 4A.

In FIG. 10, the print tile 302 comprises an end plate 362 on which a protection wall 363 is provided to extend around fluid connectors 380, 382, alignment holes 384, 386 and threaded hole 388, as described with respect to FIG. 3. The fluid connectors 380, 382, alignment holes 384, 386 and threaded hole 388 are not visible in FIG. 10A, but are shown and described with respect to FIGS. 10B-10E. The protection wall 363 provides a pool for collecting print material that may leak out when the print tile 302 is disconnected from the supply arrangement 428. The end plate 362 further comprises the electronics opening 390 described with respect to FIG. 3, and an electronic connector 1060 exposed in the electronics opening 390. The electronic connector 1060 is coupled to, or is part of, the electronic interface member 360 described with respect to FIG. 3. The electronic connector 1060 and the fluid connectors 380, 382 define a connector set of the print tile 302 to provide print material, electricity, control to the printheads of the print tile 302.

The supply arrangement 428 comprises a corresponding connector set to be coupled to the connector set of the end plate 362. For example, the connector set of the supply arrangement 428 comprises, for each print tile 302, an electronic connector 1040 to be electrically coupled to the electronic connector 1060 of the print tile 302, and fluid connectors 1080, 1082 (shown in FIGS. 10B-10E) to be fluidly coupled to the corresponding fluid connectors 380, 382 of the print tile 302. The supply arrangement 428 further comprises alignment pins 1084, 1086 to be aligned with and received in alignment holes 384, 386 of the print tile 302, and a threaded connector 1088 (e.g., a thumb screw) to be threadedly coupled with the threaded hole 388 print tile 302. The alignment pins 1084, 1086 and corresponding alignment holes 384, 386 together define an alignment structure. In an alternative arrangement, one or more alignment holes are provided at the supply arrangement 428 and the corresponding one or more alignment pins are provided at the end plate 362. The threaded connector 1088 and the threaded hole 388 together define a fastening structure. The alignment structure and the fastening structure permit the print tile 302 to be removably attached to the supply arrangement 428 from below in a blind connection. Other configurations for alignment structures and/or fastening structures are within the scopes of various embodiments.

FIGS. 10B-10E are schematic cross-sectional views showing various states while the top part of the print tile 302 and the corresponding connector part of the supply arrangement 428 are being coupled together in a connecting process. For simplicity, the electronic connectors 1040, 1060 are omitted in FIGS. 10B-10E. In some embodiments, as the fluid connectors 1080, 1082 and 380, 382 approach and are aligned with each other, make initial connection and then are fully connected, the electronic connectors 1040, 1060 also, at the same time, approach and are aligned with each other, make initial connection and then are fully connected.

FIG. 10B shows a beginning stage of the connecting process when the print tile 302 is raised from below to approach the supply arrangement 428. FIG. 10B further shows conduits 1011, 1013 coupled to the fluid connectors 1080, 1082 to supply and return the print material when the connection is completed. The supply arrangement 428 further comprises a recess 1063 extending around the fluid connectors 1080, 1082, alignment pins 1084, 1086, and threaded connector 1088 in a manner similar to the protection wall 363 extending around fluid connectors 380, 382, alignment holes 384, 386 and threaded hole 388. The print tile 302 further comprises sealing rings 1010, 1012 extending around the corresponding fluid connectors 380, 382.

FIG. 10C shows a next stage of the connecting process when the print tile 302 comes closer to the supply arrangement 428. In this stage, the threaded connector 1088 begins to be partially received in the threaded hole 388, but has not yet made threaded connection with the threaded hole 388.

FIG. 10D shows a further stage of the connecting process when the print tile 302 comes even closer to the supply arrangement 428. In this stage, the threaded connector 1088 has made threaded connection with the threaded hole 388. In some embodiments, the threaded connector 1088 is accessible from above with a tool (not shown) that engages the threaded connector 1088, and causes the threaded connector 1088 to rotate and further threadedly engage with the threaded hole 388. As the threaded connector 1088 is rotated, the print tile 302 is drawn closer to the supply arrangement 428. The alignment pins 1084, 1086 are aligned with and then gradually enter the corresponding alignment holes 384, 386. The tapered shape at the lower ends of the alignment pins 1084, 1086 and the upwardly flared shape of the upper openings of the alignment holes 384, 386 facilitate alignment and entry of the alignment pins 1084, 1086 in the corresponding alignment holes 384, 386. As the alignment pins 1084, 1086 are received in the corresponding alignment holes 384, 386, fluid connectors 1080, 1082 are aligned with the fluid connectors 380, 382, and the recess 1063 is aligned with the protection wall 363.

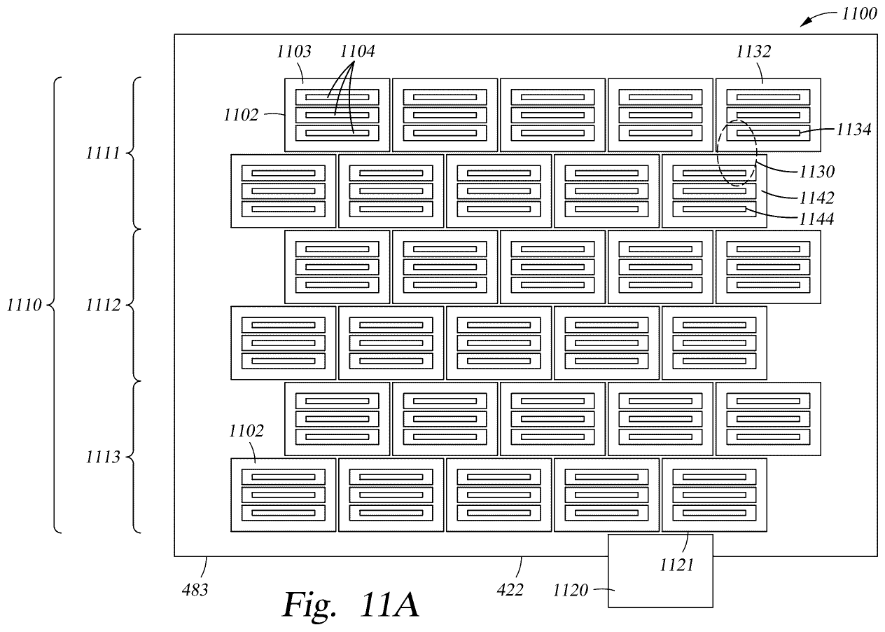

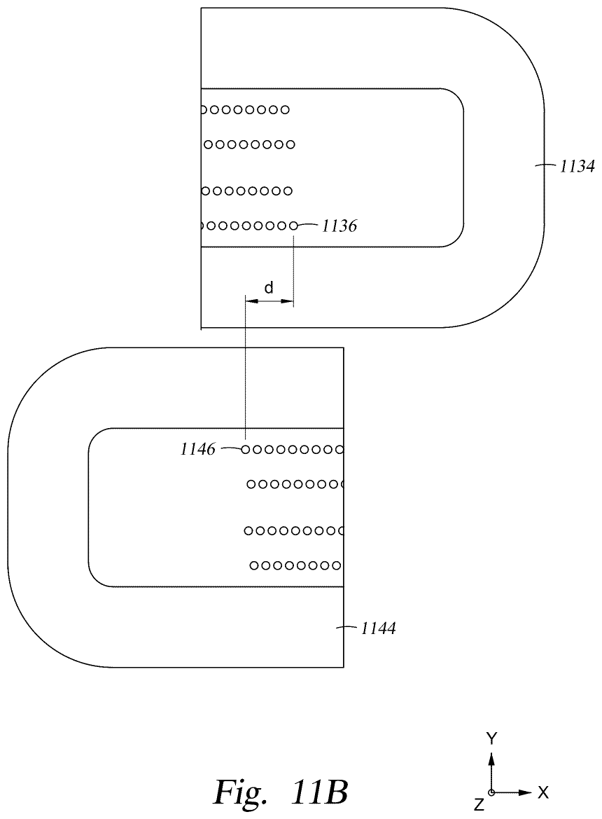

FIG. 10E shows the final stage when the connection is completed. The threaded connector 1088 and threaded hole 388 are not visible, or omitted in FIG. 10E. The alignment pins 1084, 1086 are fully received in the corresponding alignment holes 384, 386. The fluid connector 1080 is coupled with the fluid connectors 380, with the sealing ring 1010 extending around the coupled fluid connectors 1080 and 380 to seal against leakage. Likewise, the fluid connector 1082 is coupled with the fluid connectors 382, with the sealing ring 1012 extending around the coupled fluid connectors 1082 and 382 to seal against leakage. As a result, conduits 1011, 1013 are coupled in fluid-tight manner to the corresponding conduits 310, 312 to supply and return print material to and from the printheads of the connected print tile 302. The recess 1063 receives the protection wall 363 therein to provide an additional seal structure against leakage and/or foreign material around the fluid connections. Although not shown in FIG. 11E, in this final stage, the electronic connectors 1040, 1060 are also fully connected. The connected print tile 302 may be removed for service or replacement in a reversed process.

FIG. 11A is a bottom view of a printhead assembly 1100, showing an array 1110 of printheads, according to one embodiment. In some embodiments, the printhead assembly 1100 and the array 1110 correspond to one or more of the printhead assemblies and arrays of printheads described with respect to FIGS. 1, 2, 4A, 4B.

The array 1110 comprises printheads of a plurality of print tiles 1102, each including a plurality of printheads 1104. In some embodiments, the print tiles 1102 and the printheads 1104 correspond to one or more of the print tiles and printheads described with respect to FIGS. 2-10E. In each print tile 1102, the printheads 1104 are attached to a base plate 1103 by ways of corresponding nozzle plates. The printhead and nozzle plates are aligned with each other and/or with the base plate in one or more translational directions along x-, y-, z-axes and/or one or more rotational directions theta-x, theta-y, theta-z, as described herein. Each print tile 1102, with the printheads 1104 aligned and fastened thereon, are inserted into a corresponding hole in a support plate 422, pushed up and connected to a supply arrangement 428, as described with respect to FIGS. 4A4B, 10A-10. In the connected state of the print tile 1102, the base plate 1103 comes to rest on the lower surface 483 of the support plate 422.

The print tiles 1102 are arranged in multiple rows which are configured, in the example configuration in FIG. 11A, to deposit different print materials. For example, in FIG. 11A, the printheads in the two top rows 1111 deposit first print material, the printheads in the two middle rows 1112 deposit second print material, and the printheads in the two bottom rows 1113 deposit third print material. Other arrangements for depositing the same or different print materials are within the scopes of various embodiments. The print tiles 1102 and printheads 1104 in adjacent rows are arranged in a staggering arrangement. The print tiles 1102 and printheads 1104 in each rows are aligned along the x-axis direction by using a tool 1120, e.g., a plate or card, which has a known straight edge 1121. By placing the straight edge 1121 against edges of adjacent print tiles in the same row as illustrated in FIG. 11A, it is possible to ensure that the print tiles in that row are aligned along the x-axis direction. Because the printheads 1104 in each print tile 1102 are already aligned with each other and with the base plate of the print tile, all printheads 1104 in each row, and also in the whole array 1110, are aligned with each other, to a predetermined, acceptable tolerance. In an example, x-axis positions of all nozzles of a print tile are aligned to within 100 μm, y-axis positions are subject to machining tolerances, z-axis positions of all nozzles of a print tile are aligned to within 100 μm, and theta-z positions of printheads on a print tile are aligned to within 20 μrad of the x-axis direction, x-axis and y-axis positions of all print tiles in a printhead assembly are aligned to within 1 mm, and z-axis positions of all print tiles in a printhead assembly are aligned to within 100 μm.

FIG. 11B is an enlarged view of a region 1130 in FIG. 11A to show the overlap of nozzles of adjacent printheads 1134, 1144 of print tiles 1132, 1142 in adjacent rows 1111. The overlap d is the distance along the x-axis direction between the farthest nozzle 1136 to the right of the printhead 1134 and the farthest nozzle 1146 to the left of the printhead 1144. In some embodiments, the overlap d is from 0.91 to 1.12 mm.

While the foregoing is directed to embodiments of one or more inventions, other embodiments of such inventions not specifically described in the present disclosure may be devised without departing from the basic scope thereof, which is determined by the claims that follow.

1. A print tile for a printhead assembly in a printer, the print tile comprising:
a base plate having an upper surface, a lower surface opposite the upper surface in a thickness direction of the base plate, and a slot extending through the base plate from the upper surface to the lower surface;
a printhead comprising a lower part disposed in the slot and having a plurality of nozzles from which a print material is to be ejected in a printing operation;
a nozzle plate attached to the printhead; and
a plurality of mounting elements to mount the nozzle plate to the base plate, while permitting adjustment of a position of the printhead relative to the base plate,
wherein
the nozzle plate has opposite first and second end portions, and
the base plate comprises first and second adjustable lifts correspondingly under the first and second end portions of the nozzle plate, to adjust positions of the first and second end portions of the nozzle plate independently one from another in the thickness direction of the base plate.

2. The print tile of claim 1, wherein
the plurality of mounting elements comprises first and second fastening elements correspondingly fastening the first and second end portions of the nozzle plate to the base plate.

3. The print tile of claim 2, further comprising a spacer having a predetermined thickness disposed between the upper surface of the base plate and the first end portion of the nozzle plate or the second end portion of the nozzle plate.

4. The print tile of claim 2, further comprising a plurality of spacers of different predetermined thicknesses, with a first spacer of the plurality of spacers disposed around the first fastening element between the first end portion of the nozzle plate and the upper surface of the base plate and a second spacer of the plurality of spacers is disposed around the second fastening element between the second end portion of the nozzle plate and the upper surface of the base plate.

5. The print tile of claim 2, wherein
the plurality of mounting elements further comprises a position adjusting element to engage with a side of the nozzle plate and to adjust the position of the nozzle plate in a rotational direction about an axis oriented in the thickness direction of the base plate.

6. The print tile of claim 2, wherein
the plurality of mounting elements further comprises a conical screw having a conical surface to engage with the first end portion of the nozzle plate and to adjust a position of the first end portion in a rotational direction about an axis at the second end portion of the nozzle plate, the axis oriented in the thickness direction of the base plate.

7. The print tile of claim 6, wherein
the plurality of mounting elements further comprises a biasing element to engage with the first end portion of the nozzle plate,
the first fastening element is arranged between the conical screw and the biasing element, and
the biasing element elastically biases the first end portion of the nozzle plate toward the conical screw.

8. The print tile of claim 6, wherein
the plurality of mounting elements further comprises a further mounting element engaging the first end portion of the nozzle plate, and
the first fastening element is arranged between the conical screw and the further mounting element.

9. The print tile of claim 2, wherein
the plurality of mounting elements further comprises a position fixing element, or a position adjusting element, to engage with the second end portion of the nozzle plate to fix, or adjustably fix, a position of the second end portion in a longitudinal direction of the nozzle plate, while permitting a position of the first end portion of the nozzle plate to vary in the longitudinal direction due to thermal expansion of the nozzle plate.

10. The print tile of claim 9, wherein
the plurality of mounting elements further comprises a wave washer disposed around the first fastening element, and between the first end portion of the nozzle plate and a nut or a head of the first fastening element, to secure the first end portion of the nozzle plate to the base plate, while permitting thermal expansion of the nozzle plate.

11. The print tile of claim 9, wherein
the second end portion of the nozzle plate has a notch to receive the position fixing element or the position adjusting element.

12. The print tile of claim 1, wherein the slot is a first slot, the printhead is a first printhead, the nozzle plate is a first nozzle plate, and the plurality of nozzles is a first plurality of nozzles, and further comprising:
a second slot extending through the base plate;
a second printhead comprising a lower part disposed in the second slot and having a second plurality of nozzles for ejecting the print material in the printing operation, and
a second nozzle plate attached to the second printhead and the base plate,
wherein
the second nozzle plate has opposite first and second end portions,
the base plate further comprises a first pad disposed between the first end portion of the second nozzle plate and the base plate and a second pad disposed between the second end portion of the second nozzle plate and the base plate, and
the first and second adjustable lifts are adjustable to align the first nozzle plate and the first printhead to the second nozzle plate and the second printhead on the first and second pads.

13. The print tile of claim 1, wherein
at least one of the first and second adjustable lifts comprises a differential screw,
the differential screw has first threads engaged with the base plate and second threads engaged with a head of the first fastening element,
a first thread pitch of the first threads is different from a second thread pitch of the second threads, and
the head of the first fastening element engages the first end portion from below.

14. The print tile of claim 1, wherein
the first or second fastening element has first threads engaged with the base plate, second threads engaged with a nut, and a support comprising a raised pad between the first threads and the second threads, and
the corresponding first or second end portion of the nozzle plate is fastened between the support and the nut.

15. A print tile for a printhead assembly in a printer, the print tile comprising:
a base plate having an upper surface, a lower surface opposite the upper surface in a thickness direction of the base plate, and a plurality of slots extending through the base plate from the upper surface to the lower surface;
a plurality of printheads, each comprising a lower part disposed in a corresponding slot of the plurality of slots and a plurality of nozzles for ejecting print material in a printing operation;
a plurality of nozzle plates, each nozzle plate attached to a corresponding printhead of the plurality of printheads and comprising opposite first and second end portions; and
a plurality of mounting elements to mount the plurality of nozzle plates to the base plate,
wherein the plurality of mounting elements comprises, for each nozzle plate among the plurality of nozzle plates,
a first fastening element to fasten the first end portion of the nozzle plate to the base plate and a second fastening element to fasten the second end portion of the nozzle plate to the base plate, and
a conical screw having a conical surface to engage with the first end portion of the nozzle plate and to adjust a position of the first end portion in a rotational direction about an axis at the second end portion of the nozzle plate, the axis oriented in the thickness direction of the base plate.

16. The print tile of claim 15, wherein, for each nozzle plate among the plurality of nozzle plates,
the plurality of mounting elements further comprises a biasing element elastically biasing the first end portion of the nozzle plate toward the conical screw, and
the first fastening element is arranged between the conical screw and the biasing element.

17. The print tile of claim 15, wherein, for each nozzle plate among the plurality of nozzle plates,
the second end portion of the nozzle plate has a notch with sidewalls that taper toward each other in a longitudinal direction of the nozzle plate from the second end portion to the first end portion of the nozzle plate,
the base plate has a threaded hole in the upper surface that is exposed by the notch, and
the plurality of mounting elements further comprises
a position fixing pin removably disposed in the threaded hole to engage with the sidewalls of the notch to fix a position of the second end portion in the longitudinal direction of the nozzle plate and in a transverse direction crossing the longitudinal direction, or
a further conical screw removably threaded into the threaded hole to engage with the sidewalls of the notch to adjustably fix the position of the second end portion in the longitudinal direction of the nozzle plate and in the transverse direction.

18. The print tile of claim 17, wherein, for each nozzle plate among the plurality of nozzle plates,
the nozzle plate is unconstrained in the longitudinal direction away from the notch, or
the plurality of mounting elements further comprises a wave washer around the first fastening element and disposed between the first end portion of the nozzle plate and a nut or a head of the first fastening element, to permit thermal expansion of the nozzle plate.

19. The print tile of claim 15, wherein
at least one nozzle plate among the plurality of nozzle plates has the first and second fastening elements placed on corresponding raised pads on the upper surface of the base plate, and
at least one further nozzle plate among the plurality of nozzle plates has the first and second fastening elements placed on corresponding adjustable lifts, to adjust positions of the first and second end portions independently one from another in the thickness direction of the base plate.

20. A printhead assembly for an inkjet printer, the printhead assembly comprising:
a housing;
a supply arrangement supported at an upper portion of the housing; and
a plurality of print tiles removably supported at a lower portion of the housing;
wherein
each of the plurality of print tiles comprises:
a base plate having a plurality of slots,
a plurality of printheads each partially received in a corresponding slot among the plurality of slots and comprising a plurality of nozzles from which a print material is to be ejected in a printing operation,
a plurality of nozzle plates correspondingly attached to the plurality of printheads,
a plurality of mounting elements adjustably fastening the plurality of nozzle plates to the base plate, and
above the plurality of printheads, a connector set comprising at least one fluid connector and at least one electrical connector fluidly and electrically coupled, respectively, to the plurality of printheads, and
the supply arrangement comprises, for each of the plurality of print tiles, a corresponding connector set coupled to the connector set of the print tile when the print tile is removably attached to the supply arrangement from below by a fastening structure and an alignment structure, wherein the alignment structure comprises
at least one alignment pin on one of the supply arrangement and the print tile, and
at least one alignment hole on the other of the supply arrangement and the print tile, the at least one alignment pin being aligned with and received in the at least one alignment hole.
